(19) United States
(12) Patent Application Publication
(10) Pub. No.: US 2023/0234025 A1
(43) Pub. Date: Jul. 27, 2023

(54) BLENDED SORBENTS FOR GAS SEPARATION USING MOISTURE SWING REGENERATION

(71) Applicant: SVANTE INC., Burnaby (CA)

(72) Inventors: Joel CIZERON, Burnaby (CA); Jinzhong Andrew LIU, Richmond (CA); Omid GHAFFARI-NIK, Burnaby (CA); Pierre HOVINGTON, Boucherville (CA); Nima MASSOUMIFARD, Burnaby (CA); Sabereh REZAEI, Burnaby (CA)

(21) Appl. No.: 18/011,963

(22) PCT Filed: Jun. 25, 2021
(86) PCT No.: PCT/IB2021/055699

§ 371 Date: Dec. 21, 2022

Related U.S. Application Data
(60) Provisional application No. 63/044,893, filed on Jun. 26, 2020.

(51) Int. Cl. B01J 20/22; B01D 53/62; B01D 53/02; B01D 53/96; B01J 20/26; B01J 20/10; B01J 20/28; B01J 20/34; C01B 32/50

(52) U.S. Cl. CPC B01J 20/226; B01D 53/62; B01D 53/02; B01D 53/96; B01J 20/262; B01J 20/103; B01J 20/28016; B01J 20/28035; B01J 20/3466; B01J 20/3425; C01B 32/50; B01D 2253/25; B01D 2253/304; B01D 2259/4009; B01D 2257/504; B01D 2256/12; B01D 2256/10; B01D 2258/0283; B01D 2253/204; B01D 2253/202; C01B 2210/0003

(57) ABSTRACT

Sorptive gas separators can employ contactors having various sorbents blended together. The various sorbents used to make a blended sorbent contactor can be selected for their various physical and chemical properties, which will allow operators to customize formulations and structural configurations to obtain optimum performance of sorptive gas separators using blended sorbents.

### FIELD

Embodiments disclosed herein generally relate to sorbents used for gas separation processes using moisture swing regeneration, and more specifically relate to blended sorbent formulations and their methods of use.

### BACKGROUND

Sorptive gas separation processes are amongst the most common form of industrial separation processes, together with distillation and membrane based separations.

As skilled persons in the industry would understand, the cost of a sorptive separation process is largely impacted by the amount of sorbent required to produce a certain throughput of purified product. This throughput per mass of sorbent is a simple product of sorption cycle capacity and sorption cycle time. In thermal swing or chemical swing processes, desorption of a molecule sorbed onto a solid sorbent (of a contactor) can be a relatively slow process due to the requirement of the introduction of energy for desorption and the transfer of that energy into the sorbent.

A conventional moisture swing sorptive gas separation process can typically employ two fundamental steps: 1) a sorption step; 2) and a regeneration step. During a typical sorption step, a feed stream, such as a multi-component fluid mixture having a low partial pressure of water or relative humidity, can be admitted into an adsorbent separator having a contactor comprising a sorbent material. The feed stream can pass through the contactor during which time, a target component of the feed stream can adsorb onto the sorbent material, thereby separating the target component (now sorbed onto the sorbent material) from the remaining components of the feed stream. As part of the sorption step, the remaining components can form a first product stream which can be recovered from the adsorbent separator. Subsequently, during a regeneration step, a regeneration fluid stream having a high relative humidity (relative to the feed stream), for example, a steam, can be admitted into the adsorbent separator to come in contact with and directly heat the sorbent material of the contactor, purging, or otherwise desorbing the sorbed target component from the sorbent material of the contactor. A water component from the regeneration stream or steam, undergoes a phase change and sorbs onto the sorbent material, releasing a heat of adsorption at the same time. A portion of the heat of adsorption released can be used as a portion of the heat of desorption or energy required for desorbing the target component from the sorbent during the regeneration step.

The desorbed molecules and steam can be recovered as a second product stream. Water molecules in the second product stream can then be separated from the target component in the second product stream by condensation thus increasing the purity of the target component.

A subsequent or second regeneration step or conditioning step can be employed to desorb the water sorbed on the sorbent material, prior to repeating the next sorption step and cycle.

Moisture swing induced desorption of a target molecule can provide a fast and efficient means of desorbing sorbed molecules, with a resulting product stream high in purity. This process is described in PCT International Publication No. WO 2017/165974 A1.

Additional benefits of moisture swing or relative humidity swing gas separation processes for desorption include: rapid introduction of energy to the sorbent during regeneration of a sorbent by using the heat of adsorption or condensation of the moisture onto the sorbent to distribute heat energy relatively homogeneously within the porous sorbent; water, if environmentally friendly, can be discharge to the atmosphere if desired; and sorbents with significant water sorption capacity are fairly common due the hydrogen bounding capacity of water.

Drawbacks of conventional sorbent materials exposed to water and/or steam during a sorptive separation process include: water adsorbing strongly onto an adsorbent material resulting in an energy intensive and relatively long desorption process due to time required to dry the sorbent material; the adsorbent material degrading in the presence of water (for example, polymeric amine adsorbents can migrate due to partial solvation making them mobile, and with MOF adsorbents, its structure undergoes phase transition in the presence of steam resulting in pore collapse and/or loss of selective adsorption capacity), and/or a water stability attribute is inversely related to one or more desirable attributes (for example, target molecule adsorption capacity and/or reaction kinetics).

Furthermore, conventional adsorptive gas separators and processes can use an adsorbent bed or contactor consisting of a single adsorbent material throughout the adsorbent bed where a regeneration step can include, admitting a steam into the adsorptive bed via an inlet, flowing the steam in contact with the adsorbent material through the adsorbent bed, desorbing a target molecule, producing a product stream, and recovering the product stream from the adsorbent bed via an outlet. A drawback of this approach is an adsorbent material can be selected based on a desired criteria for a specific application, for example, water stability, which is often inversely related to one or more desirable attributes, including for example, target molecule adsorption capacity and/or reaction kinetics.

Also, under normal operating conditions of a sorptive gas separation process other components in the feed stream or regenerating gas stream, for example, oxygen, nitrogen oxides, and sulfur oxides can also degrade the sorbent and/or reduce the sorptive capacity of the sorbent over repetitive cycles, similar to steam or water.

Regeneration of contactors having single adsorbent materials selected for water stability can also employ an excess amount of steam than desired.

Sorbent material are typically formed into extrudates, pellets or structured sorbent contactors to enable the efficient distribution of fluids to purify or remove one or several compound from. Low parasitic thermal mass structure sorbent contactor of particular interest for rapid cycling separation are described in PCT International Publication Nos. WO 2010/096916 A1 and WO 2018/085927 A1.

In order to mitigate the effects of water on sorbents, conventional adsorptive gas separators and processes can also employ multiple stage sorbent beds or contactors, having a first stage and a second stage fluidly connected in series, where the sorbents in the second stage are guarded from water in a feed stream by sorbents in the first stage. In multiple stage sorbent beds, sorbents in the first stage are typically used to sorb and separate only water from the feed stream, not the target component. The first stage, containing an adsorbent formulated to adsorb and separate water, can be fluidly connected upstream of the second stage to remove water from the feed stream. The dry feed stream can then be recovered from the first stage and fed to the second stage. The sorbents in the second stage are then used to separate the desired target component from the feed stream. Furthermore, regeneration of the sorbent in the second stage can employ regeneration methods which do not use steam, therefore eliminating the exposure of the sorbent to steam.

Shortcomings of using multiple stage sorbent beds include: only one sorbent is employed for sorbing and separating the target component resulting in an increased sorbent and capital cost and separator volume; regeneration of two different sorbents which can increase the complexity, process cycle time, energy for regeneration; and cost of the process; and a reduced process efficiency.

Other conventional sorptive gas separators, such as, for example, packed bed sportive separators, can employ more than one sorbent. However, only one of the more than one sorbent, can be used for sorbing and separating the desired target component from the feed stream. Shortcomings of this approach include: an increased sorbent and capital cost; regeneration of two or more different sorbents which can increase the complexity, process cycle time, energy for regeneration, and cost of the process; decreased sorbent efficiency.

### SUMMARY

Sorptive gas separators can use or employ a contactor having a plurality of sorbents thereon. However, unlike the sorptive gas separators known today, embodiments of the present invention can employ contactors having various sorbents blended together, the blended sorbents having different formulations in powdered form and/or different structural configurations.

In a broad aspect, a blended sorbent powder for separating a gas mixture comprises one or more tolerant sorbent material, and one or more intolerant sorbent material, wherein a sorbent weight of said one or more tolerant sorbent material is equal to or greater than 20% of a sorbent weight of said blended sorbent powder.

In another broad aspect, a blended sorbent powder comprises a first tolerant sorbent material, wherein said first tolerant sorbent material is at least one of steam tolerant, oxidation tolerant, NOₓ tolerant, and/or SOₓ tolerant, which further comprises a water sorption capacity, a water heat of sorption, a target molecule heat of sorption, and a target molecule sorption capacity, and one or more second sorbent material further comprising a water sorption capacity, a water heat of sorption, a target molecule heat of sorption, and a target molecule adsorption capacity. In embodiments, said first tolerant sorbent material and said second sorbent material differ by at least one of a water sorption capacity, a water heat of sorption, a target molecule sorption capacity, and a target molecule heat of sorption, and a sum product of said water sorption capacity multiplied by said water heat of sorption of said one or more first tolerant sorbent material and said one or more second sorbent material is greater than a sum product of said target molecule sorption capacity multiplied by said target molecule heat of sorption of said first tolerant sorbent material and said one or more second sorbent material.

Further, in another broad aspect, a formed blended sorbent structure for separating a gas mixture comprises one or more first sorbent material, and one or more second sorbent material, for combining with said one or more first sorbent material forming a blended sorbent. In embodiments, a sorbent weight of said one or more first sorbent material is equal to or greater than 20% of a sorbent weigh of said blended sorbent, and said one or more first sorbent material is at least one of a tolerant sorbent material, a steam tolerant sorbent, an oxidation tolerant sorbent, a NOₓ tolerant sorbent, and/or a SOₓ tolerant sorbent.

Further still, in another broad aspect, a formed blended sorbent structure for separating a gas mixture comprises one or more first sorbent material, and one or more second sorbent material. In embodiments, said one or more first sorbent material is at least one of a tolerant sorbent material, a steam tolerant sorbent, an oxidation tolerant sorbent, a NOₓ tolerant sorbent, and/or a SOₓ tolerant sorbent, and said one or more first sorbent material further comprising a water sorption capacity, a water heat of sorption, a target molecule heat of sorption, and a target molecule sorption capacity, said one or more second sorbent material further comprising a water sorption capacity, a water heat of sorption, a target molecule heat of sorption, and a target molecule sorption capacity, and a sum product of said water sorption capacity multiplied by said water heat of sorption of said one or more first sorbent material and said one or more second sorbent material is greater than a sum product of said target molecule sorption capacity multiplied by said target molecule heat of sorption of said one or more first sorbent material and said one or more second sorbent material.

Further still, in another broad aspect, a formed blended sorbent structure for separating a gas mixture comprises a plurality of tolerant sorbent materials having at least a first tolerant sorbent and a second tolerant sorbent for forming a blended sorbent, wherein said first tolerant sorbent and said second tolerant sorbent have different sorption isotherms for water sorption, and is at least one of a steam intolerant sorbent, an oxidation intolerant sorbent, and a NOₓ intolerant sorbent, and/or a SOₓ intolerant sorbent. In embodiment, a sorbent weight of said first tolerant sorbent material is equal to or greater than 20%, of a sorbent weigh of said blended sorbent.

Further still, in another broad aspect, a parallel passage sorbent contactor comprises a plurality of a formed blended sorbent structure, a plurality of a fluid passages, a first port fluidly connected to said plurality of fluid passages located at a first end of said formed blended sorbent structure, and a second port fluidly connected to said fluid passages located at a second end of said formed blended sorbent structure, wherein said plurality of said formed blended sorbent structure at least partially define said plurality of said fluid passages.

Further still, in another broad aspect, a sorptive gas separation process for separating a gas stream, said gas stream comprising at least a first molecule and a second molecule, the process comprises the steps of:

(a) providing a sorbent contactor having a plurality of a formed blended sorbent structures;

(b) admitting said gas stream into said first port or said second port of said sorbent contactor;

(c) adsorbing at least a portion of said first molecule on and/or in said formed blended sorbent structure, having at least one or more first sorbent material or said one or more tolerant sorbent material, and one or more second sorbent material or said one or more intolerant sorbent material;

(d) recovering a first product fluid enriched in said second molecule from said first port or said second port of said sorbent contactor;

(e) admitting a steam stream into said first port of said sorbent contactor;

(f) desorbing at least a portion of said first molecule sorbed on at least one of said formed blended sorbent structure, said one or more first sorbent material, said one or more tolerant sorbent material, said one or more second sorbent material, and said one or more intolerant sorbent material; and

(g) recovering at least a portion of said first molecule from said second port of said sorbent contactor.

### BRIEF DESCRIPTION OF THE DRAWINGS

FIG. 1A is a graph illustrating computer simulated plots of water and carbon dioxide loading along a length of a adsorbent contactor during a regeneration step of a sorptive gas separation process using steam after two seconds from the start of a regeneration step;

FIG. 1B is a graph illustrating computer simulated plots of water and carbon dioxide loading along a length of a sorbent contactor during a regeneration step of a sorptive gas separation process using steam after four seconds from the start of a regeneration step;

FIG. 1C is a graph illustrating computer simulated plots of temperature profiles of gas phase temperature and adsorbent solid phase temperature along a length of a sorbent contactor during a regeneration step of a sorptive gas separation process using steam after two seconds from the start of a regeneration step;

FIG. 1D is a graph illustrating computer simulated plots of temperature profiles of gas phase temperature and adsorbent solid phase temperature along a length of a sorbent contactor during a regeneration step of a sorptive gas separation process using steam after four seconds from the start of the regeneration step;

FIG. 2 is a graph illustrating computer simulated plots of steam exposure duration and temperature exposure duration along a length of a sorbent contactor during a regeneration step of a sorptive gas separation process using steam after four seconds from the start of a regeneration step;

FIG. 3 is a graph illustrating computer simulated plot of sorption capacity loss of a polymeric amine adsorbent along a length of a sorbent contactor after 1000 hours of operation while using steam for regeneration of the adsorbent;

FIG. 4A is a cross-sectional view of an embodiment of the present invention, illustrating a blended sorbent powder having an intolerant sorbent material and a tolerant sorbent material substantially homogeneously distributed;

FIG. 4B is a cross-sectional view of an embodiment of the present invention, illustrating an encapsulated blended sorbent powder having an intolerant sorbent material encapsulated by a tolerant sorbent material;

FIG. 4C is a cross-sectional view of an embodiment of the present invention, illustrating a layered blended sorbent structure having an intolerant sorbent material configured as a proximal layer and a tolerant sorbent material configured as a distal layer;

FIG. 5A is a cross-sectional view of an embodiment of the present invention, illustrating a separated staged sorbent structure having a first stage having a tolerant sorbent located adjacent to a steam stream inlet, and a second stage having an intolerant sorbent;

FIG. 5B is a cross-sectional view of an embodiment of the present invention, illustrating a separated staged sorbent structure having a first stage having a heterogeneously distributed mixture of a tolerant and intolerant sorbents, and a second stage having the intolerant sorbent. The first stage of the sorbent contactor having a heterogeneously distributed mixture of a tolerant adsorbent and an intolerant sorbent located adjacent to a steam stream inlet;

FIG. 5C is a cross-sectional view of an embodiment of the present invention, illustrating a formed blended sorbent structure where tolerant and intolerant sorbents are present along the length of the formed blended sorbent structure. The darker shade shows a higher weight percentage loading of the tolerant or intolerant sorbents, which are shown offset from each other;

FIG. 6A is a graph illustrating computer simulated plots of adiabatic temperature, water adsorption, and carbon dioxide desorption, and the effect of dosing with steam on an exemplary first sorbent material;

FIG. 6B is a graph illustrating computer simulated plots of adiabatic temperature, water adsorption, and carbon dioxide desorption, and the effect of dosing with steam on an exemplary second sorbent material;

FIG. 6C is a graph illustrating computer simulated plots of adiabatic temperature, water adsorption, and carbon dioxide desorption, and the effect of dosing with steam on an exemplary blended sorbent material or structure comprising the first sorbent material and the second sorbent material in accordance to FIGS. 6A and B;

FIG. 6D is a column chart illustrating carbon dioxide loading and water loading on the first sorbent material and on the second sorbent material, compared with carbon dioxide loading and water loading of a blended sorbent material having the first sorbent material and the second sorbent material;

FIG. 6E is a column chart illustrating adiabatic temperatures of the first sorbent material, second sorbent material, and blended sorbent material having the first and second sorbent materials recorded at steady state operation; and

FIG. 7 is a process flow diagram of an embodiment of the present invention, illustrating a sorptive gas separation process for separating a first component from a multi-component gas stream using a contactor having a blended sorbent.

### DETAILED DESCRIPTION

### Definitions

Sorbent: a porous solid material, having a single chemical formulation, capable of adsorbing, and/or absorbing a molecule by chemisorption and/or physisorption, having a sorption equilibrium capacity equal to or greater than 0.1 mmol/g equilibrium capacity at operating conditions for a target component or molecule.

Sorbent powder: a sorbent particle having one or more sorbents.

Blended sorbent: two or more sorbent materials, for example, at least one tolerant sorbent and at least one intolerant sorbent, combined to form a sorbent mixture where the two or more sorbents can be substantially homogeneous or heterogeneous distributed within the combined sorbent mixture or blended sorbent. A blended sorbent can form different physical configurations including but not limited to, a blended sorbent powder (for example, a homogeneous blended sorbent powder or an encapsulated blended sorbent powder) or a formed blended sorbent (for example, a separated staged sorbent structure, a homogeneous blended sorbent structure, an encapsulated blended sorbent structure, a layered blended sorbent structure).

Homogeneous blended sorbent: a plurality of sorbent materials, for example, at least one tolerant sorbent and at least one intolerant sorbent, combined to form a sorbent mixture where the plurality of sorbent materials are substantially homogeneous distributed within the blended sorbent mixture or blended sorbent. Homogeneous blended sorbents can be used to form a formed blended sorbent or a sorbent sheet, both with or without a sorbent support or a sorbent substrate.

Encapsulated blended sorbent: an intolerant sorbent substantially encapsulated, enveloped or otherwise surrounded by a tolerant sorbent to form a blended sorbent powder or particle. The intolerant sorbent is located in a core or interior, while the tolerant sorbent is located about a shell or exterior surface of the encapsulated blended sorbent. Encapsulated blended sorbents can be used to form a sorbent sheet with or without a sorbent support or a sorbent substrate.

Separated staged sorbent: at least one tolerant sorbent and at least one intolerant sorbent which are substantially physically separate, which can optionally be on a sorbent support or a sorbent substrate.

Supported sorbent: a structure having one or more sorbent materials attached in or on a sorbent support or substrate.

Layered blended sorbent structure: a sorbent support or a sorbent substrate having a plurality of sorbent layers attached to at least an outside surface or perimeter of the sorbent support or sorbent substrate, where the first or outer layer comprises a tolerant sorbent material and the second or inner layer comprises an intolerant sorbent material.

Sorbent sheet: self-supported sheet, active layer, or laminate, with a thickness between 0.1 and 3.0 millimeter with at least a length or a width of a sorbent sheet being 100 times greater than the thickness. For example, sorbent sheets can be cut into ribbons where its width is at least 10 times greater than the thickness of the sheet.

Formed blended sorbent structure: a blended sorbent powder, for example, a homogeneous blended sorbent or an encapsulated blended sorbent, aggregated into millimeter sized particles, millimeter sized pellets, or larger objects such as a sorbent sheet, which can be used in a pack-bed vessel or a sorbent contactor, which contacts a process fluid. A formed blended sorbent can optionally have a binder and/or sorbent support. Formed blended sorbent structures can be configured as, but not limited to, a separated staged sorbent structure, a homogeneous blended sorbent structure, an encapsulated blended sorbent structure, or a layered blended sorbent. A plurality of formed blended sorbents can form a contactor and/or a sorbent separator such as a parallel passage sorbent separator or a packed bed sorbent separator.

Parallel passage sorbent contactor: a plurality of formed blended sorbent structures which define at least a portion of a plurality of substantially parallel passages. A parallel passage sorbent contactor can optionally have an enclosure to house the parallel passages and the plurality of formed blended sorbent structures. A feed stream, such as a gas mixture, and a regenerating stream or a desorbing stream, can be admitted into the parallel passages to come in direct contact with the sorbent material and/or blended sorbent structures.

Tolerant sorbent: a sorbent which meet or exceed the definition for at least one of a steam tolerant sorbent, an oxidation tolerant sorbent, nitrogen oxide (herein referred to as “NOₓ”) tolerant sorbent, and/or a sulfur oxide (herein referred to as “SOₓ” tolerant sorbent.

Intolerant sorbent: a sorbent which fails to meet or exceed the definition for at least one of a steam tolerant sorbent, an oxidation tolerant sorbent, a NOₓ tolerant sorbent, and/or a SOₓ tolerant sorbent.

Steam tolerant sorbent: porous solid sorbent capable of maintaining a loss of less than 10% in sorption capacity, sorption energetics, and/or sorption kinetics, after exposure to conditions of >95% relative humidity (herein referred as “RH”) at temperatures between 80° C. and 120° C. for greater than 100 hours.

Oxidation tolerant sorbent: capable of maintaining a loss of less than 10% in sorption capacity, sorption energetics, and/or sorption kinetics, after exposure to air at a temperature of about 110° C. for greater than 4 hrs.

NOx tolerant sorbent: capable of maintaining a loss of less than 10% loss in sorption capacity, sorption energetics, and/or sorption kinetics, after exposure to 50 ppm of nitrogen oxide, or 50 ppm nitrogen dioxide for 24 hrs at a temperature where a sorbent operates, such as, 40° C. to 80° C.

SOₓ tolerant sorbent: capable of maintaining a loss of less than 10% in sorption capacity, sorption energetics, and/or sorption kinetics after exposure to 50 ppm of sulfur dioxide, or 50 ppm sulfur trioxide mixture for 24 hrs at a temperature where a sorbent operates, such as, 40° C. to 80° C.

Target cycle capacity: amount of desired target molecule captured by a sorption-desorption separation cycle under steady state operation.

Cyclic capacity: amount of target molecules purified or extracted from a product stream recovered from a contactor or sorbent separator during a sorption-desorption separation cycle per amount of total sorbent mass.

Heat capacity (herein referred as “Cₚ”): ratio of an amount of energy required to raise a temperature of a component, for example, a sorbent, or sorbent mixture, optional sorbent support, optional sorbent binders and other inactive molecules in thermal contact in a sorbent contactor, by a certain threshold temperature before and after application of energy.

Heat of sorption: amount of energy released by removing a molecule from a gas phase and attaching it to a solid or supported liquid.

Water sorbent material: porous solid sorbent material having a weight which increases greater than 5% when exposed to a condition of greater than 60% RH.

Target compound sorbent material: porous solid sorbent material having a weight which increases greater than 1% when exposed to a condition where a feed stream or feed mixture is at a temperature in a range of 40° C. to 80° C.

Problems with Using Steam for Regeneration

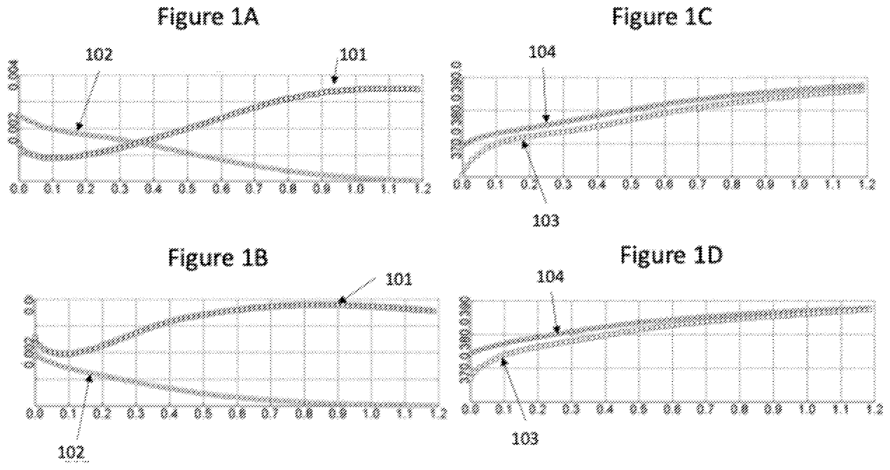

With reference to FIGS. 1A to 1D, dynamic computer simulation plots of sorbent loading profiles of water 101 and carbon dioxide (CO₂) 102 are shown for a regeneration step of a gas separation process targeting the removal of CO₂ from a feed stream in a typical gas separation using moisture swing regeneration. Although not show, a gaseous feed stream enters a sorbent contactor at a proximal end and travels axially therealong to exit the sorbent contactor at a distal end thereof, producing a first product stream. The X-axis illustrates the axial length of the sorbent contactor beginning at the proximal end in meters. As shown, a length of the sorbent contactor is about 1.2 meters. Accordingly, the distal end of the sorbent contactor is about 1.2 meters. Steam, which is used as the regeneration stream is introduced to the sorbent contactor at the distal end of the sorbent contactor, and axially travels along the sorbent contactor towards the proximal end thereof, in a direction opposite to the direction of flow of the feed stream.

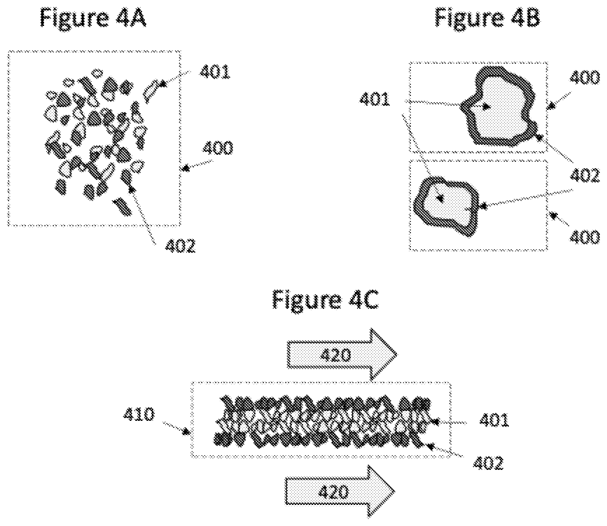

More specifically, with reference to FIGS. 1A, and 1B, dynamic computer simulated plots of sorbent loading profiles along the axial direction of the sorbent contactor, for water 101, and CO₂ 102 are shown. The plots are illustrative of the regeneration step of a sorptive gas separation process at 2 seconds (in FIG. 1A) and 4 seconds (in FIG. 1B). The X-axis represents an axial length or location of a sorbent contactor in meters, while the Y-axis represents loading in moles per gram of the sorbent material. Steam is introduced to the sorbent contactor at 383 degrees Kelvin from a steam inlet or feed outlet end adjacent the distal end of the sorbent contactor, and the steam travels axially along the sorbent contactor towards a steam outlet or feed inlet end adjacent the proximal end of the sorbent contactor (located at 0 meter axial location along the X-axis).

FIGS. 1A and 1B demonstrate sorbents, located closer to the distal end of the contactor, where steam is admitted, (about the 0.6-1.2 meter), are subjected to a greater water loading relative to the sorbents located at the opposite and proximal end of the contactor (about the 0.0-0.6 meter). A greater water loading can damage and decreasing the durability of a steam intolerant sorbent.

FIGS. 1C and 1D, shows dynamic simulated plots of temperature along the axial direction of the sorbent contactor at the same time and conditions as in FIGS. 1A, and 1B. FIG. 1C occurs at 2 seconds and Fig. D occurs at 4 seconds from the start of the regeneration step of the sorptive gas separation process using steam. The X-axis represents an axial length or location of a sorbent contactor in meters, while the Y-axis represents temperature in degrees Kelvin. A sorbent solid phase temperature is shown as plot 103 while a gas phase temperature is shown as plot 104.

FIGS. 1C and 1D illustrate sorbents, located closer to the distal end of the contactor where steam is admitted (1.2 meter), are subjected to higher temperatures relative to the sorbents located at the opposite proximal end of the contactor (0.0 meter). Subjecting sorbents to a higher temperature can damage and decrease the durability of an intolerant sorbent.

It can also be observed in FIGS. 1A and 1B, that the sorbents adjacent to the proximal end of the contactor (0 meter axial location along the X-axis) are subjected to lower water adsorption loading of the solid or sorbent as well as lower temperatures of the solids or sorbents. This can be explained by a reduced partial pressure of the steam in the gas phase being in equilibrium with the sorbent, as desorbed CO₂ is diluting the steam as it progresses through the contactor. Thermal inertia can also be another factor which can cause lower water adsorption loading of the solid or sorbent at the proximal end of the contactor. Conversely, the contactor adjacent the distal end (1.2 meter axial location along the X-axis) can be subjected to higher water adsorption loading of the sorbent as well as higher temperatures of the sorbents.

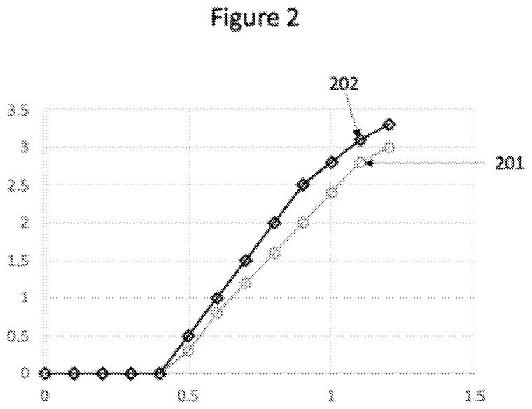

FIG. 2 demonstrates simulated plots of exposure durations across a length of a contactor, during a regeneration step of a sorptive gas separation process using steam as a regeneration stream. Once again, the X-axis represents an axial length or location of the sorbent contactor in meters, while the Y-axis represents a duration in seconds. Steam can be introduced from the distal end as before (located at 1.2 meter axial location along the X-axis) and can travel along the contactor towards the proximal end or feed inlet (0 meter axial location along the X-axis). For the purposes of this plot, steam was admitted for 4 seconds. A steam plot 201, shows steam exposure duration above 3 mmol of adsorbed water per gram of sorbent at an axial location of the contactor. A temperature plot 202, shows temperature exposure duration exceeding 380 degrees Kelvin at an axial location of the contactor. These durations are a result of dynamic simulation for a CO₂ purification cycle using a supported amine sorbent with a steam flux sufficient to desorb about 70% of the CO₂ captured on the sorbent.

As shown, FIG. 2 demonstrates that the sorbents located closer to the distal end of the contactor (or the end where steam in introduced) are subjected to the steam and temperature exposure thresholds for a longer duration. About one third of the contactor was not exposed to 3 mmol water loading of the solids or higher than 380 degrees Kelvin (0 to 0.4 meters), while about another third of the contactor (between 0.4 to 0.8 meters) is exposed to less than 2 seconds per cycle under these conditions. The longer exposure above the steam and temperature exposure thresholds can assist in decreasing the durability of an intolerant sorbent.

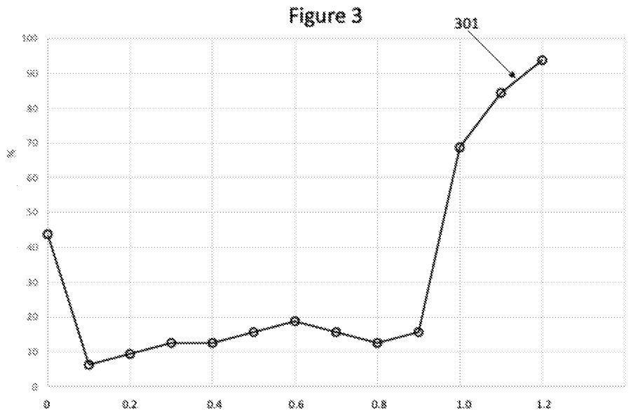

FIG. 3 shows a loss in sorption capacity to a polymeric amine-based sorbent along a contactor, after 1000 hours of operation while using steam for regeneration of the sorbent. The X-axis represents an axial length or location of a sorbent contactor in meters, while the Y-axis represents a sorption capacity loss in percentage. Steam is introduced from the distal end (located at 1.2 meter axial location along the X-axis) and moves along the contactor towards a steam outlet or feed inlet adjacent to the proximal end of the contactor (0 meter axial location along the X-axis).

Analysis of deactivation profiles with extensive testing demonstrate a similar gradation loss of sorbent capacity which can be linked to the regeneration step of the sorptive gas separation process, using steam as a regeneration stream. As shown in FIG. 3, a capacity loss plot 301, shows an example of steam induced CO₂ degradation profile or sorption capacity loss propagating from the steam inlet end (1.2 meter axial location on the x-axis). The polymeric amine-based material was configured as a laminate sorbent sheet which experiences excess water condensation during part of the process (near the vessel wall). While part of the contactor remains mostly intact, a part of the contactor with a greater sorption of steam and steam exposure loses a large fraction of its CO₂ sorption capacity. This type of damage tends to propagate over time as material aging impacts the temperature profile in the contactor and the water sorption profile during steam regeneration. With sufficient time, all of the sorbent within the contactor can be impacted. If there was no propagation, over design of the sorbent contactor volume could be a solution to this problem, however, the Applicant believes that this would not be a viable solution because of a “snowball” effect where degradation at one end affects a downstream section of the contactor or vessel. FIG. 3 demonstrates a greater loss in sorption capacity for the sorbents located closer to the distal end or the end of the contactor where steam is admitted.

Solutions to Mitigate Damage from Moisture

Possible solutions for mitigating the damaging effects of using steam as a regeneration stream in contactors having steam intolerant sorbent materials can be blended sorbents comprising various formulations of a tolerant sorbent material mixed with intolerant sorbent materials to advantageously increase a durability of the intolerant sorbent material without a large decrease in sorption capacity of the blended or combined sorbent.

In embodiments, it is desirable that a ratio of a weight of one or more tolerant sorbent materials (tolerant to steam, oxygen, NOₓ, SOₓ) to a total weight of a blended sorbent material can be equal to or greater than about 20%. In embodiments, this ratio can be preferably equal to or greater than about 30%, or more preferably equal to or greater than about 40%. Small amounts of tolerant sorbent materials, for example, less than 20%, are unlikely to sufficiently impact the overall thermal properties and response of a blended sorbent during steam regeneration of a sorptive process. Although small amounts of tolerant sorbent materials for example, less than 20%, can be sufficient to achieve NOₓ and SOₓ protection for encapsulated core/shell structures, such small amounts of tolerant sorbent materials would not be sufficient to mitigate the damaging effects of steam.

In embodiments, mitigation of the damaging effects of moisture (ie. protection) considered in this disclosure is not limited to protection against moisture induced sorbent degradation. Blended sorbents disclosed herein can also be used to protect intolerant sorbents when exposed to nitrogen oxides, sulfur oxides or oxygen by reducing the load of sorbed nitrogen oxides, sulfur oxides, or oxygen on the sorbent material. In other embodiments, the blended sorbents of the present invention can be used to change a desired regeneration temperature of the blended sorbent while using steam in a regeneration step of a sorptive separation process. Both the tolerant and intolerant sorbent materials are water sorbent and target compound sorbent materials. Accordingly, while use of segmented beds or layered sorbent structures to protect against degradation from nitrogen oxides or sulfur oxides is well known, the combination of using blended sorbents while reducing the desired regeneration temperature while using steam in a regeneration step of a sorptive gas separation process is novel and unique as the blended sorbent needs to meet certain requirements relative to steam regeneration separation performance which may be thermally coupled.

In another embodiment, a blended sorbent can comprise a desired energy balance between the energy needed to desorb the target molecule and the amount of energy released when water sorbs on the blended sorbent, for example, during a regeneration step of a sorptive gas separation process. In one aspect of the embodiment, and in the case of CO₂ gas separation applications, a blended sorbent can comprise a water sorption capacity such that the sum of the products of a water (cyclic) sorption capacity multiplied by a heat of sorption for water for each sorbent is greater than the sum of the products of a target molecule, for example, CO₂, (cyclic) target sorption capacity multiplied by a target molecule, for example, CO₂, heat of sorption for each sorbent, as illustrated in equation (1).

Σ_{sorbents}Q_{water-cyclic}*ΔH_{ads-water}>Σ_{sorbents}Q_{Select-cyclic}*ΔH_{ads-Select} (1)

where:
Σ_{sorbents}=sum of the products for each sorbent
Q_{water-cyclic}=sorption cyclic capacity of water, during cyclic operation
ΔH_{ads-water}=heat of sorption of water
Q_{select-cyclic}=sorption cyclic target capacity of a target molecule (for example, CO₂), during cyclic operation
ΔH_{ads-Select}=heat of sorption of a target molecule (for example, CO₂)

In another embodiment, optionally, a water sorption capacity of said one or more tolerant sorbent material, for example, a steam tolerant sorbent, an oxidation tolerant sorbent, a NOₓ tolerant sorbent, and/or a SOₓ tolerant sorbent, is equal to or greater than about 20%, 30%, or 40% of a water sorption capacity of a blended sorbent, at a steam regeneration design condition, such as when water sorption is at its maximum capacity, during a regeneration step in a sorptive separation process, for example, when the blended sorbent is at a temperature between 100° C. to 160° C.

A blended sorbent, for example, separated staged sorbents, homogeneous blended sorbents and/or encapsulated blended sorbents, can be formed into, but limited to, a sheet or laminate to form a formed blended sorbent structure, while retaining most of the sorption properties, for example, sorption capacity and sorption energetics, of the individual sorbents. In an embodiment, formed blended sorbent structures (such as a separated staged sorbent structure, a homogeneous blended sorbent structure, a encapsulated blended sorbent structure, or a layered blended sorbent), can have a thickness in a range of about 100 micrometers to about 3000 micrometers.

A thermal swing or induced thermal swing sorptive gas separation process can be significantly impacted by the thermal capacity of blended sorbents and their optional sorbent support or substrate. In embodiments, a sorbent separator, a contactor, a formed blended sorbent or a supported blended sorbent can comprise a blended sorbent, an sorbent support, for example, a laminate or sheet, and a ratio of a heat capacity of the active components or sorbent materials to a heat capacity of each component including the sorbent support, binders and other chemically passive components of the sorbent support, laminate or sheet, as illustrated in equation (2).

Σ_{sorbents}Cp_{sorbent}*Mass_{sorbent}>0.75*Σ_{components}Cp_{component}*Mass_{component} (2)

where:
Σ_{sorbents}=sum of the products for each sorbent
Cp_{sorbent}=heat capacity of an active component or a sorbent
Mass_{sorbent}=mass of a sorbent
Σ_{components}=sum of products for each sorbent support, laminate, or sheet
Cp_{component}=heat capacity of a sorbent support, laminate, or sheet
Mass_{component}=mass of a sorbent support, laminate, or sheet.

In an embodiment of a sorbent contactor, a sum of the products of a total heat capacity of active components or sorbents is greater than a sum of the products of a total heat capacity of a sorbent support, laminate, or sheet. In another embodiment of a sorbent contactor, a sum of the products of a total heat capacity of active components or sorbents by mass fraction of the active components is greater than a sum of the products of the heat capacity by mass fraction for all of the components in the formed material including sorbent components, a sorbent support, or total heat capacity of the laminate, or sheet, multiplied by 0.75.

In embodiment of a formed blended sorbent or a supported blended sorbent, a sum of the products of a heat capacity of active components or sorbents is greater than a sum of the products of a heat capacity of a sorbent support, laminate, or sheet. In another embodiment of a formed blended sorbent or a supported blended sorbent, a sum of the products of a heat capacity multiplied by weight fraction of active components or sorbents is greater than a sum of the products of a heat capacity multiplied by weight fraction of a sorbent components including sorbent, support and other non-active additives in the laminate, or sheet, multiplied by 0.75.

In optional embodiments, a water sorption capacity of one or more tolerant sorbent materials (tolerant to steam, oxygen, NOₓ, SOₓ) can be equal to or greater than about 20% of a water sorption capacity of a blended sorbent under steam regeneration condition, such as when water sorption is at its maximum capacity, during a regeneration step of a sorptive separation process, for example, when the blended sorbent is at a temperature between 100° C. to 160° C. In embodiments, this capacity can be preferably equal to or greater than about 30%, or more preferably equal to or greater than about 40%.

Blended Sorbent Powders

In embodiments, one or more tolerant sorbent materials can be combined with one or more intolerant sorbent materials to form a blended sorbent powder which can be used to form, for example, a sorbent sheet with a sorbent support (a supported sorbent structure), a sorbent sheet without a sorbent support (a self-supported sorbent structure), a sorbent pellet with or without a sorbent support, a sorbent contactor, or a sorbent monolith. One or more sorbent sheet with or without a sorbent support, sorbent pellet with or without a sorbent support, sorbent contactor, or sorbent monolith, can be used to form a sorbent gas separator herein referred a sorbent separator. Blended sorbent powders can be configured as homogeneous blended sorbent powders or encapsulated blended sorbent powders.

In one aspect, a sorbent material described hereinbelow can be any of: desiccant, activated carbon, graphite, carbon molecular sieve, activated alumina, molecular sieve, aluminophosphate, silicoaluminophosphate, zeolite adsorbent, ion exchanged zeolite, hydrophilic zeolite, hydrophobic zeolite, modified zeolite, natural zeolites, faujasite, clinoptilolite, mordenite, metal-exchanged silico-aluminophosphate, uni-polar resin, bi-polar resin, aromatic cross-linked polystyrenic matrix, brominated aromatic matrix, methacrylic ester copolymer, carbon fiber, carbon nanotube, nano-materials, metal salt adsorbent, perchlorate, oxalate, alkaline earth metal particle, ETS, CTS, metal oxide, supported alkali carbonates, alkali-promoted hydrotalcites, chemisorbent, amine, organo-metallic reactant, a metal organic framework (MOF) adsorbent, a polyethylenimine doped silica (PEIDS) sorbent, porous polymers such as co-polymers with functionalized monomers and structure forming monomers, in general porous material containing amines, carboxylic acids, other water adsorbent groups, transition metals, acidic or basic functional groups or atom clusters, an amine containing porous network polymer sorbent, an amine doped porous material sorbent, an amine doped MOF sorbent, a doped activated carbon, a doped graphene, an alkali-doped or rare earth doped porous inorganic sorbent, amorphous or semi-crystalline porous materials such as high surface area silica, silica or silicates, templated meso-porous silica, functionalized silica or silicates, amorphous carbon, functionalized amorphous carbon.

Referring to FIGS. 4A and 4B, an embodiment of blended sorbent powders having two different sorbent materials or chemical formulations are shown. In FIG. 4A, a homogeneous blended sorbent powder is shown, while FIG. 4B illustrate an embodiment encapsulated blended sorbent powder.

In alternative embodiment of a blended sorbent powder having at least a first tolerant sorbent material and a second tolerant sorbent material (tolerant to steam, oxygen, NOₓ, SOₓ) for forming a blended sorbent powder where the first tolerant sorbent material and the second tolerant sorbent material have different sorption isotherms for water sorption, and an optional sorbent support or forming elements for creating sheets or laminates or millimeter scale particles of the blended sorbent powder.

Homogeneous Blended Sorbent Powders

In one embodiment, one or more tolerant sorbent materials can be combined with an intolerant sorbent material to form a blended sorbent powder or mixture having a substantially homogeneous distribution within the mixed powder, herein referred to as a homogeneous blended sorbent powder. Both the tolerant and intolerant sorbent materials can be water sorbent and target compound sorbent materials, and can have different energetics for water sorption.

As shown in FIG. 4A, an embodiment of a homogeneous blended sorbent powder 400 can comprise an intolerant sorbent material 401, combined with a tolerant sorbent material 402, where the intolerant sorbent material 401 and the tolerant sorbent material 402 are substantially homogeneously distributed within the homogeneous blended sorbent powder 400.

During a desorption or regeneration step of a sorptive gas separation process where steam is used as a regeneration stream, a sorbent material can reach a maximum adiabatic temperature at which the loading of steam on the sorbent material stops, at a specific steam partial pressure of a regeneration fluid and temperature of the sorbent material. This adiabatic temperature is the result of the initial sorbent temperature and the exothermic water sorption or condensation process induced temperature rise. For steam, at atmospheric pressure, the maximum adiabatic temperature is typically between 105° C. and 150° C., depending on the sorbent material. Typically, under substantially identical conditions, a steam tolerant sorbent has a maximum adiabatic temperature greater than a maximum adiabatic temperature of a steam intolerant sorbent material.

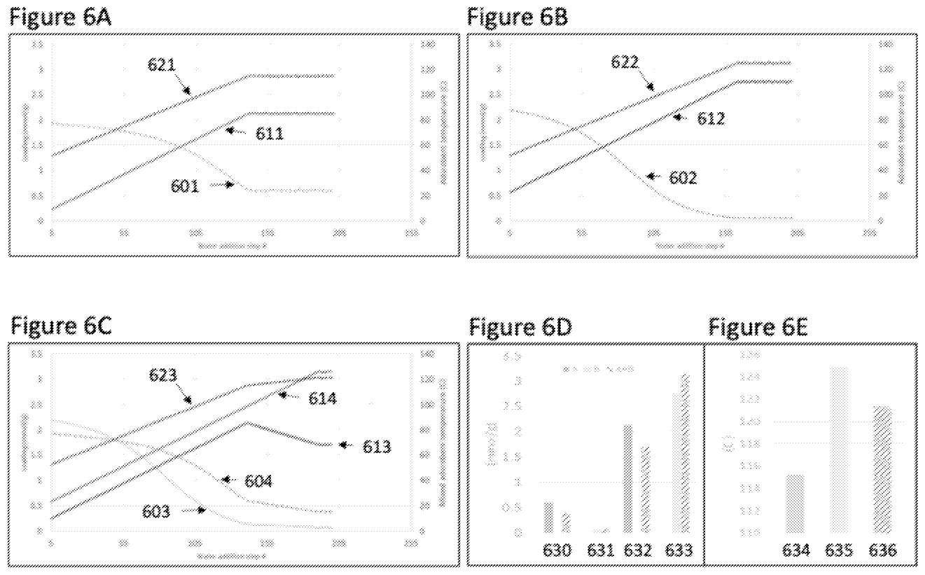

When tolerant and intolerant sorbent materials are combined and blended, the substantially homogeneous sorbent mixture or blend can reach a blended maximum adiabatic temperature which typically falls within a temperature range between a maximum adiabatic temperature of the tolerant sorbent material and a maximum adiabatic temperature of the intolerant sorbent material. At a maximum adiabatic temperature for a homogeneous sorbent mixture, a water loading of an intolerant sorbent material (having a lower adiabatic temperature) will have a lower moisture loading relative to its moisture loading as if unblended at substantially similar conditions, as illustrated in FIGS. 6A, 6B, and 6C, and further discussed herein below.

This can be explained by a shift in equilibrium water loading of the steam intolerant sorbent material in the homogeneous blended sorbent. In this example, as the steam tolerant sorbent material has an increased capacity to adsorb water at a high temperature relative to the intolerant sorbent material, this increases the effective maximum adiabatic temperature of the steam intolerant sorbent and in a sense “overheats” the intolerant sorbent material which at the overheat conditions and temperatures desorbs water.

Sorbents and their many deactivation mechanisms, for example, phase change, have switch-like properties and thresholds where even a modest change in an operating condition, for example, steam loading, can result in the sorbent material undergoing an irreversible change or degradation. A similar example relates to filling of porous sorbent pores with liquid water which also has a relatively sharp threshold to RH.

With some porous solid intolerant sorbents, activation of the degradation mechanism can be more sensitive to temperature than moisture loading. In this case, blending an intolerant sorbent material with a tolerant sorbent material to form a homogeneous blended sorbent can result in lowering an effective maximum adiabatic temperature of the tolerant sorbent material (under a certain steam partial pressure) which can be advantageous. For a homogeneous blended sorbent, a tolerant sorbent material with a reduced effective maximum adiabatic temperature can act as a thermal buffer for the intolerant sorbent material by releasing water and cooling of the homogeneous blended sorbent or mixture above a temperature threshold.

In an alternative embodiment, a sorbent material with a high selectivity or affinity for a target molecule with limited water sorption capacity can be combined with a steam intolerant sorbent material to form a homogeneous blended sorbent powder. The homogeneous blended sorbent powder can have an increase in overall heat capacity relative to the sorption capacity for the target molecule compared to the individual sorbent. Therefore, the homogeneous blended sorbent powder would experience a diminished effective maximum adiabatic temperature of the tolerant sorbent when exposed to the target molecule. It can also be the case during a regeneration step where steam can sorb onto the sorbent material with a high affinity for a target molecule with limited water sorption capacity.

In another embodiment, a sorbent separator and/or at least one sorbent contactor optionally having at least one supported sorbent for separation of a component from a multi-component gas stream can comprise one or more steam tolerant sorbent materials combined with a steam intolerant sorbent material to form a homogeneous blended sorbent material, and at least one fluid passage in fluid connection with the homogeneous blended sorbent material.

In another embodiment, a sorbent separator and/or at least one sorbent contactor optionally having at least one supported sorbent for separation of a component from a multi-component gas stream can comprise a first sorbent material with a high affinity or selectivity for a target molecule and limited water sorption capacity, a second or steam intolerant sorbent material, where the first sorbent material and the second sorbent material are combined to form a homogeneous blended sorbent material, and at least one fluid passage in fluid connection with the homogeneous blended sorbent material.

Encapsulated Blended Sorbent Powders

In one embodiment, an intolerant sorbent material can be encapsulated by a tolerant sorbent material to form an encapsulated blended sorbent powder. Encapsulation of the intolerant sorbent material can be carried out during synthesis of the tolerant sorbent material, where the tolerant sorbent material can form a capsule, envelope or shell around particles of the intolerant sorbent material which forms a core of the encapsulated blended sorbent powder. The capsule or shell formation can also be achieved by aggregation of fine particles of the tolerant sorbent material with, for example, coating of a shell material or the deposition of an amorphous carbon layer around a particle of silica.

With encapsulated blended sorbent powders having a core/shell geometry or configuration, an additional mechanism to increase tolerance, for example, steam, oxidation, NOₓ, and/or SOₓ, can be by adjusting properties of the sorbent material, for example, the first or tolerant sorbent material, of the shell to alter the kinetic of sorption, saturation, and transport of water through the shell material. The gradient of steam across the shell and core of the encapsulated blended sorbent powder drives faster sorption at the outer surface or shell of the encapsulated blended sorbent powder relative to the core of the encapsulated blended sorbent powder. As the pores of the sorbent material of the shell reach pore filling conditions, it can advantageously reduce and/or slow the transport of steam to the sorbent material, for example, the intolerant sorbent material, of the core. For rapid cyclic operation, kinetic driven sorption selectivity can be used effectively to avoid reaching equilibrium sorption capacity in the core of an encapsulated blended sorbent powder.

As shown in FIG. 4B, an encapsulated blended sorbent powder 400 can comprise individual particles of an intolerant sorbent material 401 forming a core of encapsulated blended sorbent powder 400 and can be encapsulated by a tolerant sorbent material 402, which forms a shell of encapsulated blended sorbent powder 400. In this case, sorbent material 401 will be the least tolerant sorbent material to be exposed to steam. Sorbent material 402 acting as a sorbent for steam, oxygen, NON or SOₓ can partially or totally restrict a gas or steam from diffusing to sorbent material 401 for the duration of the process step.

Some sorptive gas separation processes using steam as a regeneration stream can be designed to operate having a relatively short cycle, for example, less than one minute. In these applications, an encapsulated blended sorbent powder can reduce or prevent the exposure of intolerant sorbent material 401 to NON and SO_{N}. An encapsulated blended sorbent powder can enable a change in an operating temperature and gradient of diffusing gas composition within the powder, such as within tolerant sorbent material 402 and/or intolerant sorbent material 401, which can advantageously result in mitigating exposure to, for example, steam and/or oxygen, and the associated loss of sorption performance.

Typical particle sizes for encapsulated blended sorbent powders are between 0.5 micrometers to 10 micrometers including the shell. For a 5 micrometer core/shell particle diameter with similar density for sorption material 401 and sorption material 402, a shell layer of 1 micrometer thick would correspond to 42% of the total mass of sorbent in the particle or powder.

While a porous coating of individual micron scale particles cannot be an effective diffusion barrier relative to a layer of meso-porous or nano-porous material with pore diameters within 0.4 nanometer to 50 nanometers as used in the example in FIG. 4B, it can be relatively more effective than a randomly mixed powder, if the sorption kinetics within the particles is of the same magnitude in time as with the diffusion through the porous network between particles. Blended sorbents configured with multiple layers of sorbents can also mitigate the need to develop slurries for the particulate mixture, as each sorbent material can desirably have different binders and dispersing agents. Therefore, blended sorbents configured with multiple layers can advantageously enable the individual layers to have different binders and/or dispersing agents which can improve the manufacturability as well as improving the performance and/or durability of a sorbent, structured sorbent and/or contactor.

In an embodiment, a sorbent separator and/or at least one sorbent contactor for separation of a component from a multi-component gas stream can comprise an intolerant sorbent material encapsulated by a tolerant sorbent material to form an encapsulated blended sorbent powder, and at least one fluid passage in fluid connection with the encapsulated blended sorbent. The sorbent contactor can comprise an encapsulated blended sorbent powder in and/or on a sorbent support or substrate.

Formed Blended Sorbent Structure

In an embodiment, a formed blended sorbent structure can comprise one or more tolerant sorbent material, and one or more intolerant sorbent material as described above. A formed blended sorbent structure can be self-supported or without a sorbent support or a sorbent substrate, or optionally supported with a sorbent support or a sorbent substrate. A formed blended sorbent structure can be configured with a separated staged sorbent, a homogeneous blended sorbent structure, an encapsulated blended sorbent structure, or a layered blended sorbent structure. A plurality of formed blended sorbents can form a contactor and/or a sorbent separator such as a parallel passage sorbent separator or a packed bed sorbent separator.

Separated Staged Sorbent Structure

Separated staged sorbents can comprise physical separation of one or more steam tolerant sorbent materials from one or more steam intolerant sorbent materials with a multi-stage sorbent geometry.

In an embodiment, a separated staged sorbent structure can comprise: a first stage having a first sorbent material or a tolerant sorbent material with a higher hydrothermal stability located substantially adjacent or closest to a first end of the separated staged sorbent structure and/or an inlet of a sorbent contactor where steam is admitted; and a second stage having an intolerant sorbent material with a lower hydrothermal stability located down steam of the first or tolerant sorbent material, a first end of the separated staged sorbent structure and/or an end of the sorbent contactor where steam is recovered. The separated staged sorbent can be self-supported or further comprise a sorbent support.

Steam can be added or admitted into a sorbent separator or a sorbent contactor, during a regeneration or a desorption step of a sorptive gas separation process. In embodiments, a quantity of steam admitted can be preferably below a saturation quantity of both the tolerant and intolerant sorbent materials, thereby reducing the quantity of steam received by the steam sensitive sorbent material or intolerant sorbent material. This advantageously results in increasing the durability of the intolerant sorbent material.

A heat of sorption generated by the sorption of water on the tolerant sorbent material in the first stage can travel in a direction substantially similar to the direction of flow of the steam and/or the desorbed target molecule, for example, CO₂, and assist in regeneration of the intolerant sorbent material in a second stage by providing at least a portion of a heat of desorption for the intolerant sorbent material.

Reducing exposure of an intolerant sorbent material having a lower hydrothermal stability to steam in the second stage can have a large impact on the durability of the intolerant sorbent material, supported sorbent, sorbent contactor, and/or separator while having little impact on the overall gas separation performance and/or sorption capacity. Both the tolerant and intolerant sorbent materials are water sorbent and target compound sorbent materials.

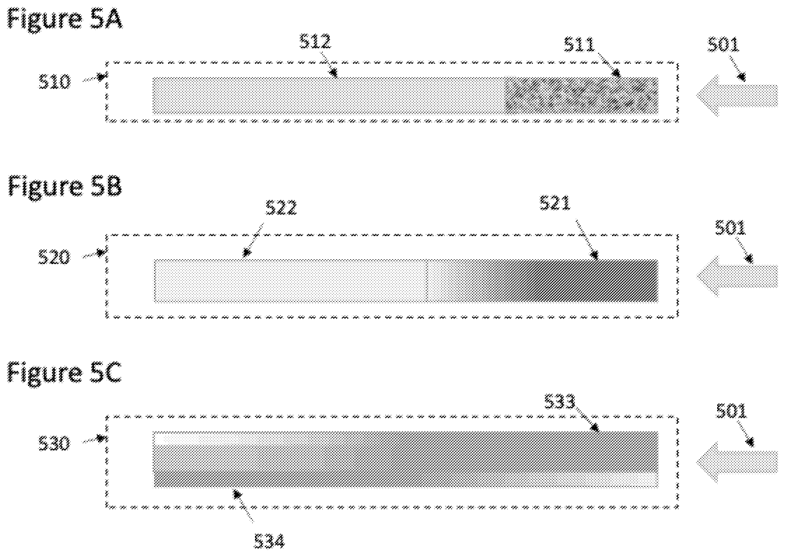

FIGS. 5A, and 5B, show various sorbent profiles of embodiments of sorbent separators, sorbent contactors or formed blended sorbents having a separated staged sorbent structure configuration.

More specifically, and shown in FIG. 5A, a separated staged sorbent structure can have a first stage and a second stage where the sorbents in each stage have different chemical formulations. As shown a sorbent profile of an embodiment of a formed blended sorbent can be configured as a separated staged sorbent structure 510, comprising a steam tolerant sorbent located in a first portion or a first stage 511 of separated staged sorbent structure 510 and a steam intolerant sorbent located in a second portion or a second stage 512 of separated staged sorbent structure 510. Steam tolerant sorbent and steam intolerant sorbent are positioned and fluidly connected in series relative to a flow direction 501, of a steam stream, with the steam tolerant sorbent material located closest to an inlet of a contactor for a steam stream, such as the distal end.

FIG. 5B shows a separated staged sorbent structure having a first stage and a second stage, where the first stage can comprise a tolerant sorbent combined with an intolerant sorbent, and the second stage comprise an intolerant sorbent. A separated staged sorbent structure can be self-supported or have a sorbent support.

More specifically, FIG. 5B shows a sorbent profile of an embodiment formed blended sorbent configured as a separated staged sorbent structure 520. In the first portion or a first stage 521 of separated staged sorbent structure 520, a heterogeneously distributed gradient of a steam intolerant sorbent material (shown as a lighter shade) blended with a steam tolerant sorbent material (shown as a darker shade). First stage 521 is closest to an inlet of a contactor for a steam stream, as shown with a flow direction 501, of the steam stream, such as the distal end. In a second portion or a second stage 522 of separated staged sorbent structure 520, a steam intolerant sorbent material is substantially homogeneously distributed (shown as an even shade).

In another embodiment, a sorbent separator and/or at least one sorbent contactor for separation of a component from a multi-component gas stream can comprise at least one separated staged sorbent structure having a first stage having a first or a tolerant sorbent material and a second stage having a second or intolerant sorbent material, and at least one fluid passage in fluid connection with the first or a tolerant sorbent material in the first stage and the second or intolerant sorbent material in the second stage, wherein the first stage is located upstream of the second stage in relation to the direction of flow of a steam stream. The sorbent gas separator can further comprise an inlet for a steam stream substantially adjacent to the first stage and an outlet for the steam stream substantially adjacent to the second stage. The separated staged sorbent can be self-supported or have a sorbent support.

Homogeneous Blended Sorbent Structure with Different Energetics for Water Sorption

In an embodiment, a homogeneous blended sorbent structure can comprise a homogeneous blended sorbent powder as disclosed herein and optionally a sorbent support, where the homogeneous blended sorbent structure is self-supported or supported on the sorbent support.

In embodiments, one or more tolerant sorbent materials can be combined with an intolerant sorbent material to form a blended sorbent powder or mixture having a substantially homogeneous distribution within the powder or mixture, herein referred to as a homogeneous blended sorbent powder. Both the tolerant and intolerant sorbent materials can be water sorbent and can be target compound sorbent materials and can have different energetics for water sorption.

During a desorption or regeneration step of a sorptive gas separation process where steam is used as a regeneration stream, a sorbent material can reach a maximum adiabatic temperature at which the loading of steam on the sorbent material stops, at a specific steam partial pressure of a regeneration fluid and temperature of the sorbent material. This adiabatic temperature is the result of the initial sorbent temperature and the exothermic water sorption or condensation process induced temperature rise. For steam, at atmospheric pressure, the maximum adiabatic temperature is typically between 105° C. and 150° C., depending on the sorbent material. Typically, under substantially identical conditions, a steam tolerant sorbent has a maximum adiabatic temperature greater than a maximum adiabatic temperature of a steam intolerant sorbent material.

When tolerant and intolerant sorbent materials are combined and blended, the substantially homogeneous sorbent mixture or blend can reach a blended maximum adiabatic temperature which typically falls within a temperature range between a maximum adiabatic temperature of the tolerant sorbent material and a maximum adiabatic temperature of the intolerant sorbent material. At a maximum adiabatic temperature for a homogeneous sorbent mixture, a water loading of an intolerant sorbent material (having a lower adiabatic temperature) will have a lower moisture loading relative to its moisture loading as if unblended at substantially similar conditions, as illustrated in FIGS. 6A, 6B, and 6C, and further discussed herein below.

This can be explained by a shift in equilibrium water loading of the steam intolerant sorbent material in the homogeneous blended sorbent. In this example, as the steam tolerant sorbent material has an increased capacity to adsorb water at a high temperature relative to the intolerant sorbent material, this increases the effective maximum adiabatic temperature of the steam intolerant sorbent and in a sense “overheats” the intolerant sorbent material which at the overheat conditions and temperatures desorbs water.

Sorbents and their many deactivation mechanisms, for example, phase change, have switch-like properties and thresholds where even a modest change in an operating condition, for example, steam loading, can result in the sorbent material undergoing an irreversible change or degradation. A similar example relates to filling of porous sorbent pores with liquid water which also has a relatively sharp threshold to RH.

With some porous solid intolerant sorbents, activation of the degradation mechanism can be more sensitive to temperature than moisture loading. In this case, blending an intolerant sorbent material with a tolerant sorbent material to form a homogeneous blended sorbent can result in lowering an effective maximum adiabatic temperature of the tolerant sorbent material (under a certain steam partial pressure) which can be advantageous. For a homogeneous blended sorbent, a tolerant sorbent material with a reduced effective maximum adiabatic temperature can act as a thermal buffer for the intolerant sorbent material by releasing water and cooling of the homogeneous blended sorbent or mixture above a temperature threshold.

In an alternative embodiment, a sorbent material with a high selectivity or affinity for a target molecule with limited water sorption capacity can be combined with a steam intolerant sorbent material to form a homogeneous blended sorbent powder. The homogeneous blended sorbent powder can have an increase in overall heat capacity relative to the sorption capacity for the target molecule compared to the individual sorbent. Therefore, the homogeneous blended sorbent powder would experience a diminished effective maximum adiabatic temperature of the tolerant sorbent when exposed to the target molecule. It can also be the case during a regeneration step where steam can sorb onto the sorbent material with a high affinity for a target molecule with limited water sorption capacity.

In another embodiment, a sorbent separator and/or at least one sorbent contactor optionally having at least one supported sorbent for separation of a component from a multi-component gas stream can comprise one or more steam tolerant sorbent materials combined with a steam intolerant sorbent material to form a homogeneous blended sorbent material, and at least one fluid passage in fluid connection with the homogeneous blended sorbent material.

In another embodiment, a sorbent separator and/or at least one sorbent contactor optionally having at least one supported sorbent for separation of a component from a multi-component gas stream can comprise a first sorbent material with a high affinity or selectivity for a target molecule and limited water sorption capacity, a second or steam intolerant sorbent material, where the first sorbent material and the second sorbent material are combined to form a homogeneous blended sorbent material, and at least one fluid passage in fluid connection with the homogeneous blended sorbent material.

Encapsulated Blended Sorbent Structure

In one embodiment an encapsulated blended sorbent structure comprise an encapsulated blended sorbent powder as disclosed herein and optionally a sorbent support, where the encapsulated blended sorbent structure is self-supported or supported on a sorbent support.

In one embodiment, a second or steam intolerant sorbent material can be encapsulated by a first or tolerant sorbent material to form an encapsulated blended sorbent powder. Encapsulation of the second or intolerant sorbent material can be carried out during synthesis of the first or tolerant sorbent material, where the first or tolerant sorbent material can form a capsule or shell around particles of the second or intolerant sorbent material which forms a core of the encapsulated blended sorbent powder. The capsule or shell formation can also be achieved by aggregation of fine particles of the first or tolerant sorbent material with, for example, coating of a shell material or the deposition of an amorphous carbon layer around a particle of silica. With encapsulated blended sorbents powders having a core/shell geometry or configuration, an additional mechanism to increase steam tolerance, for example, steam, oxidation, NOₓ, and/or SOₓ, is by adjusting properties of the sorbent material, for example, the first or steam tolerant sorbent material, of the shell to alter the kinetic of sorption, saturation, and transport of water through the shell material. The gradient of steam across the shell and core of the encapsulated blended sorbent powder drives faster sorption at the outer surface or shell of the encapsulated blended sorbent powder relative to the core of the encapsulated blended sorbent powder. As the pores of the sorbent material of the shell reach pore filling conditions, it can advantageously reduce and/or slow the transport of steam to the sorbent material, for example, the second or intolerant sorbent material, of the core. For rapid cyclic operation, kinetic driven sorption selectivity can be used effectively to avoid reaching equilibrium sorption capacity in the core of an encapsulated blended sorbent powder.

In another embodiment, a sorbent separator and/or at least one sorbent contactor for separation of a component from a multi-component gas stream comprise at least one encapsulated blended sorbent structure having a formed blended sorbent having a second or an intolerant sorbent material encapsulated by a first or tolerant sorbent material to form an encapsulated blended sorbent powder where the encapsulated blended sorbent powder is optionally on a sorbent support, and at least one fluid passage in fluid connection with the encapsulated blended sorbent structure. The formed blended sorbent can comprise an encapsulated blended sorbent powder in and/or on a sorbent support or substrate.

Layered Blended Sorbent Structure

In an alternate embodiment, a layered blended sorbent structure can comprise, at least a first layer having a tolerant sorbent material, a second layer having an intolerant sorbent material, and optionally a sorbent support or substrate having a large wetted surface area, for example, greater than about 500 m²/m³, where the first layer and the second layer are attached in and/or on the optional sorbent support, and the first layer forms an outer or distal layer and the second layer forms an inner or proximal layer and, optionally, where the first layer and the second layer are located substantially on an outside perimeter of the optional sorbent support. The sorbent support can be in a form of, for example, a sheet or a monolith. A separator and/or a contactor can comprise a plurality of layered blended sorbent structure in a form of a sheet which at least partially define a plurality of parallel passages.

The desirable spatial distribution of the sorbents in such structures are discussed below.

Sorbent supports or substrates can be self-supported sorbent sheets, or a sorbent support having a substantially flat sheet configuration. The layered blended sorbent structures can be similar in concept to the encapsulated blended sorbents where a first or tolerant sorbent material encapsulates an intolerant sorbent material however the sorbent materials are applied to formed films or larger formed particles on a sorbent support or substrate. The tolerant sorbent material can form and act as a protective layer between a process fluid stream and for the intolerant sorbent. The tolerant sorbent can be configured on a layer distal to a sorbent support or sheet, while the intolerant sorbent can be located on a layer proximal to the sorbent support or sheet. In this case, kinetic of transport can play a role in controlling the exposure and local concentration of process stream components, for example, steam and/or oxygen, to the second sorbent layer or layers beneath the first sorbent layer.

FIG. 4C, illustrates an embodiment layered blended sorbent structure 410 where an intolerant sorbent material 401 and a tolerant sorbent material 402 are configured with substantially separate layers. The intolerant sorbent material 401 can, for example, be a self-supported film, sheet or laminate and a proximal layer. Tolerant sorbent material 402 can be configured and/or applied on top and bottom of tolerant sorbent material 401 forming a sandwich structure where the outer or distal layer can provide some protection to the intolerant sorbent material at the core or proximal layer of the layered blended sorbent structure. Arrow 420 shows the general direction of a process gas stream flow in relation to the layered blended sorbent structure during a sorptive gas separation process.

While a porous coating of individual micron scale particles cannot be an effective diffusion barrier relative to a layer of meso-porous or nano-porous material with pore diameters within 0.4 nanometer to 50 nanometers as used in the example in FIG. 4B, it can be relatively more effective than a randomly mixed powder, if the sorption kinetics within the particles is of the same magnitude in time as with the diffusion through the porous network between particles. Blended sorbents configured with multiple layers of sorbents can also mitigate the need to develop slurries for the particulate mixture, as each sorbent material can desirably have different binders and dispersing agents. Therefore, blended sorbents configured with multiple layers can advantageously enable the individual layers to have different binders and/or dispersing agents which can improve the manufacturability as well as improving the performance and/or durability of a sorbent, structured sorbent and/or contactor.

In an alternative embodiment, a sorbent gas separator and/or at least one sorbent contactor for separation of a component from a multi-component gas stream comprise: a plurality of layered blended sorbent structures further comprising, at least a first layer having a tolerant sorbent material, a second layer having an intolerant sorbent material, and optionally a sorbent support or substrate having a large wetted surface area, for example, greater than about 500 m²/m³, where optionally the first layer and the second layer are attached in and/or on the sorbent support, and the first layer forms an outer layer or outer lumen and the second layer forms an inner layer or inner lumen where the first layer and the second layer are, optionally, located substantially on an outside perimeter of the optional sorbent support; and at least one fluid passage in fluid connection with the plurality of layered blended sorbent structures. The sorbent support can be in a form of, for example, a sheet or a monolith. The plurality of layered blended sorbent structures can at least partially define a plurality of fluid passages.

FIG. 5C shows a sorbent profile of an embodiment formed blended sorbent structure where both tolerant and intolerant sorbent materials are present throughout the contactor and/or a formed blended sorbent structure 530. Tolerant sorbent 533 such as a steam tolerant sorbent, is shown having a higher weight percentage loading gradient (higher gradient shown as darker in shade) located closest to an inlet of a contactor for a steam stream (such as the distal end), as shown with a flow direction 501 of the steam stream. Intolerant sorbent 534, such as a steam intolerant sorbent, is shown having a higher weight percentage loading (higher gradient shown as darker in shade) of the intolerant material located towards an outlet of the contactor for a steam stream (such as the proximal end). In FIG. 5C, the sorbent profile of tolerant sorbent 533, is shown offset from intolerant sorbent 534 in an attempt to show the weight percentage gradient profile of both tolerant sorbent 533 and intolerant sorbent 534. In an embodiment, a formed blended sorbent structure has a gradient concentration or rate of change concentration between a first end of the formed blended sorbent structure and a second end of the formed blended sorbent structure, and optionally the gradient concentration or rate of change concentration is substantially constant between the first end of the formed blended sorbent structure and the second end of the formed blended sorbent structure. Optionally, the formed blended sorbent structure may have a sorbent support.

Similar sorbent loading gradation can be also used to protect against oxidative damage, nitrogen oxides damage or sulfur oxide damage. In this case for the nitrogen oxide and sulfur oxide protection, a tolerant (to NOₓ or/and SOₓ) sorbent material is preferentially located toward the process gas or feed inlet of vessel sportive gas separator, a contactor, or a formed blended sorbent.

Any combination of the geometries disclosed above can be used to modulate the amount of water saturation of an intolerant sorbent material. Optionally, one or more tolerant sorbent materials can be used, and/or one or more intolerant sorbents can be used.

In one embodiment, a formed blended sorbent structure comprise a plurality of tolerant sorbent material having at least a first tolerant sorbent material and a second tolerant sorbent material for forming a blended sorbent powder where the first tolerant sorbent material and the second tolerant sorbent material have different sorption isotherms for water sorption; an optional sorbent support or forming elements for creating sheets or laminates or millimeter scale particles of the blended sorbent powder, wherein a sorbent weight of the first tolerant sorbent material is equal to or greater than about 20%, preferably equal to or greater than about 30%, or more preferably equal to or greater than about 40% of a sorbent weigh of the blended sorbent powder; optionally a water sorption capacity of said one or more first sorbent material is equal to or greater than about 20%, 30%, or 40% of a water sorption capacity of the blended sorbent powder at a steam regeneration design condition when water sorption is at its maximum capacity during a regenerating step of a sorptive separation process, for example, when the blended sorbent is at a temperature between 100° C. to 160° C.; and the first tolerant sorbent material and the second tolerant sorbent material is at least one of a steam tolerant sorbent, an oxidation tolerant sorbent, a NOₓ tolerant sorbent, and/or a SOₓ tolerant sorbent.

Structured Beds or Contactors

Formed blended sorbent structures including, for example, a separated staged sorbent structure, a homogeneous blended sorbent structure, a encapsulated blended sorbent structure, or a layered blended sorbent structure, described herein in the form of substantially flat sheets, such as, a laminate or sorbent sheets, can be configured to define substantially parallel passages in a parallel passage sorbent contactor, where the dimensions, for example, height, width, and length, of the parallel passages affect a permeability across the parallel passage sorbent contactor (measured in a direction of the flow of a feed and/or regeneration stream). In an embodiment of a parallel passage sorbent contactor, formed blended sorbent structure (for example, a separated staged sorbent structure, a homogeneous blended sorbent structure, a encapsulated blended sorbent structure, or a layered blended sorbent structure), or laminates, can be sized and configured in such a way that the parallel passage sorbent contactor comprise a permeability value in a range of about 2,000 to 40,000 Darcy under laminar flow conditions. The formulation or blend of sorbent materials such as blended sorbent powders and/or formed blended sorbent structures with distinct sorption properties described in this invention can be used for the purpose of separating gaseous component from a feed stream for energy production, carbon dioxide abatement, or chemical manufacturing and providing a concentrated stream of at least one component in the feed that can be further utilized or sequestrated or discarded.

In one embodiment, a sorbent separator and/or at least one sorbent contactor for separation of a component from a multi-component gas stream can comprise: a plurality of formed blended sorbent or supported blended sorbents, which at least partially define a plurality of fluid passages; an inlet at a first end of the plurality of formed blended sorbent or supported blended sorbents and fluidly connected to the plurality of fluid passages; an outlet at a second end of the plurality of formed blended sorbent or supported blended sorbents and fluidly connected to the plurality of fluid passages; and a permeability value in a range of about 2,000 to 40,000 Darcy under laminar flow conditions.

In one embodiment, a sorbent separator and/or at least one contactor for separation of a component from a multi-component gas stream can comprise: an inlet and an outlet, one or more tolerant sorbent material located substantially adjacent or closest to the inlet and within a volume of equal to or greater than about 20%, preferably equal to or greater than about 30%, or more preferably equal to or greater than about 40% of a volume of the contactor.

In an alternative embodiment, a sorbent separator and/or at least one contactor for separation of a component from a multi-component gas stream can comprise: a plurality of formed blended sorbent or supported blended sorbents (for example, a separated staged sorbent structure, a homogeneous blended sorbent structure, a encapsulated blended sorbent structure, or a layered blended sorbent structure), further comprise at least one first or tolerant sorbent material (for example, a steam tolerant sorbent, an oxidation tolerant sorbent, a NOₓ tolerant sorbent, and/or a SOₓ tolerant sorbent), and at least one second or intolerant sorbent material (for example, a steam intolerant sorbent, an oxidation intolerant sorbent, a NOₓ intolerant sorbent, and/or a SOₓ intolerant sorbent); an enclosure for housing the at least one first or tolerant sorbent material and at least one second or intolerant sorbent material; and an inlet for the enclosure, and an outlet for the enclosure. The inlet and outlet are fluidly connected to the at least one first or tolerant sorbent material and the at least one second or intolerant sorbent material.

### Method of Use of Blended Sorbent Formulation and Structures

The formulation or blend of sorbent materials, or blended sorbents with distinct sorption properties disclosed herein can be used for the purpose of separating a first component, for example, carbon dioxide, from a multi-component gas stream for industrial or utility deleterious effluent reduction and providing a concentrated stream of CO₂ that can be further utilized for sequestration or other industrial usage.

In embodiments, a sorbent separator and/or a contactor of the present invention can be used in a sorption process for separating a first component from a multi-component gas stream. Embodiments of the contractor can be provided where at least one blended sorbent, for example, separated staged sorbents, homogeneous blended sorbents, encapsulated blended sorbents and/or supported blended sorbents, optionally having distinct sorption properties disclosed herein, for example, where a weight of one or more tolerant sorbent material is equal to or greater than about 20%, 30%, or 40% of an sorbent weight of the blended sorbent and/or optionally having a steam sorption step heat generation such as:

Σ_{sorbents}Q_{water-cyclic}*ΔH_{ads-water}>Σ_{sorbents}Q_{Select-cyclic}*ΔH_{ads-Select}

Optionally, the contactor can have a heat capacity value where a sum of the products of a total heat capacity of sorbents multiplied by a mass fraction of sorbents is greater than a sum of the products of the heat capacity for all of the components in the formed material multiplied by a mass fraction for all of the components in the formed material multiplied by 0.75. Optionally, the contactor can have a permeability value in a range of about 2,000 to 40,000 Darcy under laminar flow conditions.

In a process embodiment, a sorptive gas separation process for sorptive gas separation of a multi-component fluid mixture or stream comprising at least a first component (which can comprise for example, carbon dioxide) is provided. In one such embodiment, the sorptive process can separate at least a portion of the first component from the multi-component fluid mixture or stream.

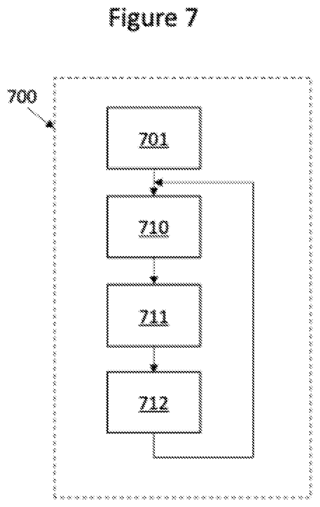

FIG. 7 illustrates an embodiment of the present invention, showing a sorptive gas separation process 700 for separation of a multi-component fluid mixture or stream comprising at least a first component (which can comprise for example, carbon dioxide) and a second component.

As shown, an initial step 701 includes providing a contactor having at least a blended sorbent powder, for example, a homogeneous blended sorbent powder or an encapsulated blended sorbent powder, and/or a formed blended sorbent structure, for example, a separated staged sorbent structure, a homogeneous blended sorbent structure, an encapsulated blended sorbent structure, or a layered blended sorbent structure. In embodiments, the process 700 can employ a parallel passage contactor comprising a plurality of formed blended sorbents or supported blended sorbents stacked on top of one another, and a plurality of spacers for creating a channel between two adjacently stacked formed blended sorbents or supported blended, and creating a plurality of channels for permitting a fluid to flow through the contactor. In embodiments, the contactor can have a permeability value of 2,000 to 40,000 Darcy under laminar flow conditions. In an embodiment, the sorptive gas separation process can employ a contactor, for example, a parallel passage contactor or a packed-bed contactor.

A multi-component gas stream, containing at least a first component such as carbon dioxide, can be admitted as a feed stream into the contactor during a sorbing step 710. As the feed stream flows through the contactor, the feed stream contacts the blended sorbent, and at least a portion of the first component of the feed stream can sorb in and/or onto the blended sorbent. Although not specifically shown, the remaining components that are not sorbed in and/or onto to sorbent material, for example, a second component such as nitrogen, can substantially flow through the contactor and exit the contactor to form a first product stream.

In embodiments, the first product stream can be depleted in the first component relative to the feed stream. In embodiments, the first product stream can also be enriched in the second component relative to the feed stream. In embodiments, the first product stream can be recovered from the contactor.

During a first regeneration step 711, at least a portion of the first component sorbed in and/or onto the at least one sorbent material can be desorbed, by at least one of a temperature swing mechanism, a pressure swing mechanism, and a partial pressure swing mechanism, to form a second product stream. In embodiments, a first regeneration stream (such as steam) can be admitted into the contactor for contacting the blended sorbent as the first regeneration stream flows through the contactor. As a result, at least a portion of the first regeneration stream (such as water from the steam) can sorb in and/or onto the blended sorbent, generating a heat of sorption. This heat of sorption of water is a result of the phase change undergone by water, for example, changing from the gas phase (steam) into the liquid phase (liquid water).

In embodiments, the heat of sorption resulting from the sorption of water onto the sorbents can be used as at least a portion of a heat of desorption for desorbing at least a portion of the first component sorbed in and/or onto the blended sorbent. Thus, in embodiments, the second product stream can be enriched in the first component relative to the feed stream. The second product stream can then be recovered from the contactor.

During an optional second regenerating step 712, the water component sorbed in and/or onto the blended sorbent can be desorbed from the blended sorbent by admitting a second regeneration stream, such as a gas stream having a low partial pressure of water, or a relative humidity less than a relative humidity within the contactor. In embodiments, desorption of the water component sorbed in and/or on the blended sorbent can be performed or assisted by applying a vacuum and reducing a pressure within the contactor to a pressure below a saturation pressure of the steam within the contactor. Components desorbed from the blended sorbents during the second regeneration step 712, can form a third product stream which can be recovered from the contactor.

Additional optional subsequent steps (not shown) can follow, for example, a cooling step where a temperature of the blended sorbent can be reduced prior to repeating the sorbing step. The cycle of the sorbing step 710, the first regeneration step 711, optional second regeneration step 712 (and optional subsequent steps) may be repeated as desired.

In an embodiment, a sorptive gas separation process for separating at least a first component from a multi-component gas stream can comprise providing a contactor described hereinabove, admitting the multi-component gas stream as a feed stream into the sorbent contactor via a feed inlet, sorbing at least a portion of the first component from the feed stream on the blended sorbent, recovering a first product stream enriched in a second component relative to the feed stream from the sorbent contactor via an outlet, admitting a first regenerating stream with a steam content greater than 80% (mole fraction) purity into the sorbent contactor via a steam inlet, sorbing steam or water on the blended sorbent and generating a heat of sorption or condensation optionally where the amount of energy released when the water sorbs onto the blended sorbent is greater than the energy desired to desorb the first component from the blended sorbent, desorbing at least a portion of the first component sorbed on the blended sorbent and forming a second product stream enriched in the first component relative to the feed stream, recovering the second product stream from the sorbent contactor via a second product stream outlet, and optionally desorbing the water sorbed on the blended sorbent optionally by admitting an optional second regeneration stream, for example, a gas stream having a relative humidity less than a relative humidity within the contactor, and/or by applying a vacuum and reducing a pressure within the contactor to a pressure below a saturation pressure of the steam within the contactor.

In embodiments, the contactor can further comprise at least one of a separated staged sorbent, a homogeneous blended sorbents, an encapsulated blended sorbent, and a supported blended sorbent, as described hereinabove, optionally having a weight of one or more tolerant sorbent material equal to or greater than about 20%, 30%, or 40% of an sorbent weight of the blended sorbent. In embodiments, the blended sorbent can have a total heat of sorption for water greater than the total heat of sorption for the target molecule

Σ_{sorbents}Q_{water-cyclic}*ΔH_{ads-water}>Σ_{sorbents}Q_{Select-cyclic}*ΔH_{ads-Select}.

In embodiments, the blended sorbents can have a heat capacity value where a sum of the products of a total heat capacity of sorbents multiplied by a mass fraction of sorbents is greater than a sum of the products of the heat capacity for all of the components in the formed material multiplied by a mass fraction for all of the components in the formed material multiplied by 0.75. In other embodiments, the contactor can have a permeability value in a range of about 2,000 to 40,000 Darcy under laminar flow conditions.

In embodiments, the first component can be carbon dioxide and the regenerating stream can be a steam stream admitted into the contactor at a temperature in a temperature range of 100° C. and 120° C.

### Illustrations

FIG. 6A illustrates a numerical simulation plot of dosing steam on a contactor comprising sorbent A that is saturated with CO₂, while FIG. 6B illustrates a numerical simulation plot of dosing steam on a contactor comprising sorbent B, also saturated with CO₂. For comparison, FIG. 6C is a numerical simulation plot of dosing steam on a blended sorbent, comprising both sorbent A and sorbent B, also saturated with CO₂. Applicant wishes to note that sorbents A and B are hypothetical materials for illustration purposes defined by chosen CO₂ and water sorption properties. As shown in all three plots, the X-axis represents a number of water addition steps within a regenerating step, while the Y-axis represents sorbent loading in mmol/g and sorbent temperature in degrees Celsius.

For sorbent material A, the effect of dosing steam is shown in FIG. 6A. For material B, the effect of dosing steam can be seen in FIG. 6B. For the blended sorbent having mixture of sorbent materials A and B (50% of each by weight), the effect of dosing steam can be seen in FIG. 6C.

As shown in FIG. 6A, a maximum adiabatic temperature with steam injection for sorbent A by itself is shown to be about 115° C. on temperature plot 621 with a maximum water sorption of about 2.2 mmol/g water loading plot 611. CO₂ desorption is shown on CO₂ loading plot 601. In FIG. 6B, a maximum adiabatic temperature with steam injection for sorbent B by itself is shown to be about 125° C. on temperature plot 622 with a maximum water sorption of about 2.75 mmol/g as seen on water loading plot 612. CO₂ desorption is shown one CO₂ loading plot 602.

In FIG. 6C, plot 603 illustrate CO₂ loading for a blended sorbent material A in mmol/g, while plot 604 illustrates CO₂ loading for blended sorbent material B. As shown, steam is adsorbed on the blended solid or sorbents, and CO₂ is desorbed therefrom. Plot 613 illustrates a water loading for blended sorbent material A, while plot 614 illustrates a water loading for blended sorbent material B. A clear transition from adsorbing steam to desorbing steam for blended sorbent material A (at an apex of plot 613) is shown in FIG. 6C, as the temperature of the mixed sorbent temperature plot 623 surpasses 100° C. Eventually blended sorbent material B also stops adsorbing steam (when plot 613 flattens) at which point CO₂ desorption is maximized for the mixed sorbent sample.

FIG. 6D shows a comparison of loading of CO₂ and water on the individual sorbent materials (at water addition step 200 on the X-axis in FIGS. 6A and 6B) to the sorbent material when combined in a blended sorbent material (at water addition step 200 on the X-axis in FIG. 6C). The X-axis represent sorbent materials, while the Y-axis represents component (CO₂ or water) loading in mmol/g. The data for sorbent material A by itself is shown as a dark shaded solid column, sorbent material B by itself is shown as a light shaded solid column, and blended sorbent material A and B is shown as hatch patterned column.

As shown in FIG. 6D, CO₂ loading column 630 shows the loading of CO₂, on sorbent material A by itself (dark shaded solid column) compared with sorbent material A in blended sorbent material A and B (hatch patterned column). CO₂ loading column 631 shows the loading of CO₂, on sorbent material B by itself (light shaded solid column) compared with sorbent material B in blended sorbent material A and B (hatch patterned column). Water loading column 632 shows the loading of water, on sorbent material A by itself (dark shaded solid column) compared with sorbent material A in blended sorbent material A and B (hatch patterned column), which illustrate the water loading of sorbent material A when combined in blended sorbent material A and B has a reduced or lower water loading. Water loading column 633 shows the loading of water, on sorbent material B by itself (light shaded solid column) compared with sorbent material B in blended sorbent material A and B (hatch patterned column), which illustrate the water loading of sorbent material B when combined in blended sorbent material A and B has an increased or higher water loading.

FIG. 6E shows a comparison of adiabatic temperatures of the individual sorbent materials (at water addition step 200 on the X-axis in FIGS. 6A and 6B) to the blended sorbent material (at water addition step 200 on the X-axis in FIG. 6C). The X-axis represent sorbent materials, while Y-axis represents temperature in ° C. As shown, the adiabatic temperatures for sorbent material A is shown as a temperature bar 634, sorbent material B is shown as a temperature bar 635, and blended sorbent material A and B is shown as a temperature bar 636. FIG. 6E shows that the adiabatic temperature of the blended sorbent material A and B is in a range between the adiabatic temperature of sorbent material A, having the lowest adiabatic temperature, and the adiabatic temperature of sorbent material B, having the highest adiabatic temperature.

This example illustrates a significant potential for reducing water loading and/or reducing the temperature of an individual sorbent in a blended sorbent mixture. Any of these techniques can be used to diminish exposure of the sorbent to a harsh environment without compromising the ability to perform an efficient separation process. In turn, the reduced exposure of the sorbent to a harsh environment can slow down or protect against chemical or phase change induced degradation of sorption performance over time, for example, as illustrated in FIG. 3.

This simulation of a slice or portion of a sorbent contactor clearly illustrate the ability to reduce steam exposure to one sorbent material through blending with another sorbent material competing for water sorption.

Combining or blending of similar sorbents with different sorption characteristics can also be used to protect against oxidative damage, nitrogen oxides damage or sulfur oxide damage. The embodiments disclosed herein offers advantages for sorbent contactors and processes where sorbent materials are subjected or exposure to both heat and steam.

Example of Performance Enhancement from Using Multi-Sorbent Structured Bed Design

A sorptive bed configured with multiple structured beds was tested for CO₂ capture from simulated flue gas using rapid cycling with steam regeneration. The beds were made with low pressure drop characteristics Darcy (8000, 12000) from sorbent sheets containing either metal organic framework sorbent (MOF) or polyethylenimide supported/dispersed on silica (PEIDS).

A reference bed with only the MOF sorbent in a 1 meter long bed was made and tested first. This bed was then cut into a 0.8 meter long segment and used as a segment in a segmented sorbent bed with the balance of the bed length made of a PEIDS containing structured sorbent.

Results of cyclic testing, for at least 2 hours (greater than 100 cycles) to reach steady operating conditions, are reported in Table 1. Two different recovery targets were evaluated by adjusting feed flow rate only. The results in the table are grouped per test cycle.

TABLE 1
Comparison of performance of 1m long structure bed with MOF only to a structure bed having
two segments, a 0.8 m long segment with MOF and a 0.2 m long segment with PEIDS sorbent.

| | | | | | | Steam Ratio |
|---|---|---|---|---|---|---|
| | | CO₂ | CO₂ product | | Productivity | (H₂O Wt/CO₂ |
| Bed design | Test cycle | Feed % | % | Recovery % | (TDP/m³) | Wt) |
| Single 1 m | 52 s | 16.8% | 91% | 74% | 10 | 2.24 |
| | baseline | | | | | |
| Dual 0.8/0.2 m | 52 s | 16.8% | 95.8% | 76% | 10.3 | 1.7 |
| | baseline | | | | | |
| Single 1 m | 52 s high | 16.5% | 93.2% | 87% | 9.3 | 2.24 |
| | recovery | | | | | |
| Dual 0.8/0.2 m | 52 s high | 16.9% | 95.6% | 88% | 9.6 | 2.28 |
| | recovery | | | | | |

The results indicate that replacement of the back end relative to the feed flow direction of the MOF with a PEIDS sorbent has a strong benefit towards improving purity of the CO₂ recovered from the bed in the segmented bed relative to the reference non-segmented bed. It also indicates having a small advantage in increasing cycle capacity for CO₂ and therefore productivity.

The advantage of the segmented bed on improved product purity can be explained by the different isotherm for the sorption material used resulting in a sharper transition from pushing inert gas through the structure sorbent to the CO₂ desorption front.

The small advantage in productivity seen for the segmented bed is related to optimizing the use of the MOF which cyclic sorption capacity for CO₂ when loaded with moisture is strongly reduced. The back end (feed direction) where steam is injected is the wettest part of the bed. Replacing this section of the bed with a material which can retain its CO₂ sorption capacity under higher moisture conditions is noticeably beneficial even if only a small fraction of the bed is replaced.

The main advantage of this segmented structure is the reduction in steam loading during the regeneration step where the steam is added in the opposite direction from the feed step. Reducing exposure of a sorbent to 100% steam feed reduces the risk of structural damage to the MOF material, resulting in extending the lifetime of the segmented bed.

In a first broad embodiment, a blended sorbent powder for separating a gas mixture can comprise one or more tolerant sorbent materials, and one or more intolerant sorbent material. In embodiments, a sorbent weight of the said one or more tolerant sorbent material can be equal to or greater than about 20%, 30%, or 40% of an sorbent weight of said blended sorbent powder, or the sorbent weight of the said one or more tolerant sorbent material can be equal to or greater than a sorbent weight of the said one or more tolerant sorbent material and one or more intolerant sorbent material.

In an embodiment of the first broad embodiment, a water sorption capacity of the said one or more tolerant sorbent material can be equal to or greater than about 20%, 30%, or 40% of a water sorption capacity of the said blended sorbent powder under steam regeneration condition, such as when water sorption is at its maximum capacity in a regeneration step of a sorptive separation process (for example, when the blended sorbent is at a temperature between 100° C. to 160° C.). Further, in embodiments, the said one or more tolerant sorbent material can be at least one of steam tolerant, oxidation tolerant, NOₓ tolerant, and/or SOₓ tolerant.

In an embodiment of the first broad embodiment, the said blended sorbent powder can have at least a 1 mmol/g sorption capacity for the target molecule for a representative sample of the full sorbent bed composition under the process condition used for sorption in a cyclic sorptive separation process.

In an embodiment of the first broad embodiment, the said one or more tolerant sorbent materials can be combined with one or more intolerant sorbent material to form a substantially homogeneous distributed mixture.

In an embodiment of the first broad embodiment, the said one or more tolerant sorbent material can substantially encapsulate the said one or more intolerant sorbent materials, and/or the said one or more tolerant sorbent material to form a distal layer and the said one or more intolerant sorbent material forming a proximal layer of said blended sorbent powder.

In an embodiment of the first broad embodiment, the said one or more tolerant sorbent materials can further comprise a water heat of sorption, a target molecule heat of sorption, a water sorption capacity, a target molecule target sorption capacity, and the said one or more intolerant sorbent material can further comprise a water heat of sorption, a target molecule heat of sorption, a water sorption capacity, a target molecule target sorption capacity, and a sum product of said water sorption capacity multiplied by said water heat of sorption of said one or more tolerant sorbent material and said one or more intolerant sorbent material can be greater than a sum product of said target molecule cyclic sorption capacity multiplied by said target molecule heat of sorption of said one or more tolerant sorbent material and said one or more intolerant sorbent material.

In a second broad embodiment, a blended sorbent powder can comprise one or more first sorbent material, and one or more second sorbent material. In embodiments, the one or more first sorbent material can be at least one of a tolerant sorbent material, steam tolerant sorbent, oxidation tolerant sorbent, NOₓ tolerant sorbent, and/or SOₓ tolerant sorbent, and said one or more first sorbent material can further comprise a water sorption capacity, a water heat of sorption, a target molecule heat of sorption, and a target molecule sorption capacity. Further, in embodiments, one or more second sorbent material can further comprise a water sorption capacity, a water heat of sorption, a target molecule heat of sorption, and a target molecule sorption capacity, wherein a sum product of said water sorption capacity multiplied by said water heat of sorption of said one or more first sorbent material and said one or more second sorbent material can be greater than a sum product of said target molecule sorption capacity multiplied by said target molecule heat of sorption of said one or more first sorbent material and said one or more second sorbent material.

In an embodiment of the second broad embodiment, said one or more second sorbent material is at least one of an intolerant sorbent material, a steam intolerant sorbent, an oxidation intolerant sorbent, a NOₓ intolerant sorbent, and/or a SOₓ intolerant sorbent.

In another embodiment of the second broad embodiment, said one or more second sorbent material is at least one of: a tolerant sorbent material, a steam tolerant sorbent, an oxidation tolerant sorbent, a NOₓ tolerant sorbent, a SOₓ tolerant sorbent, an intolerant sorbent material, a steam intolerant sorbent, an oxidation intolerant sorbent, a NOₓ intolerant sorbent, and/or a SOₓ intolerant sorbent.

In a third broad embodiment, a formed blended sorbent structure for separating a gas mixture can comprise one or more first sorbent material, and one or more second sorbent material, for combining with said one or more first sorbent material forming a blended sorbent powder, wherein a sorbent weight of said one or more first sorbent material can be equal to or greater than about 20%, 30%, or 40% of an sorbent weigh of said blended sorbent powder, and wherein said one or more first sorbent material can be at least one of steam tolerant, oxidation tolerant, NOₓ tolerant, and/or SOₓ tolerant.

In an embodiment of the third broad embodiment, a water sorption capacity of said one or more first sorbent material can be equal to or greater than about 20%, 30%, or 40% of a water sorption capacity of said blended sorbent powder at a steam regeneration design condition such as when water sorption can be at its maximum capacity during a regeneration step of a sorptive separation process, for example, when the blended sorbent is at a temperature between 100° C. to 160° C.

In an embodiment of the third broad embodiment, said formed blended sorbent structure further comprise a sorbent support or forming elements for creating sheets or laminates, or millimeter scale particles of said blended sorbent powder.

In an embodiment of the third broad embodiment, wherein said sorbent support is in a form of a sheet, a substantially flat sheet, a planar sheet, and/or a laminate, with a thickness in a range of between 100 micrometers to 3000 micrometers.

In an embodiment of the third broad embodiment, a sum a heat capacity of said one or more first sorbent material and a heat capacity of said one or more second sorbent material heat capacities is equal to or greater than about 75% of a heat capacity of said formed blended sorbent.

In an embodiment of the third broad embodiment, the said formed blended sorbent and/or said sorbent support can be in a form of a sheet, a substantially flat sheet, a planar sheet, and/or a laminate with a thickness in a range of between about 100 micrometers to about 3000 micrometers.

In an embodiment of the third broad embodiment, said formed blended sorbent structure or said sorbent support further comprise a first end and a second end, and/or a first portion and a second portion of said formed blended sorbent structure or said sorbent support, wherein said one or more first sorbent material can be substantially homogeneously distributed and/or substantially located in said first portion and/or adjacent to said first end of said formed blended sorbent structure or said sorbent support. In embodiments, said one or more second sorbent material can be substantially homogeneously distributed and/or substantially located in said second portion and/or adjacent to said second end of said formed blended sorbent structure or said sorbent support, and said one or more first sorbent material can be juxtaposed to said one or more second sorbent material.

In an embodiment of the third broad embodiment, said formed blended sorbent structure and/or said sorbent support can further comprise a first end, and a second end of said formed blended sorbent structure or said sorbent support, and/or a first portion and a second portion of said formed blended sorbent structure or said sorbent support, wherein said one or more first sorbent material and said one or more second sorbent material are heterogeneously distributed and/or located on said formed blended sorbent structure or said sorbent support. In a further embodiment, the second sorbent material is at least one of: steam intolerant, oxidation intolerant, NOₓ intolerant, and/or SOₓ intolerant

In an embodiment of the third embodiment, said first end of said formed blended sorbent structure and/or said first portion of said sorbent support can have a higher concentration of said one or more first sorbent material relative to said second end and/or said second portion of said formed blended sorbent or said sorbent support, and/or a lower concentration of said one or more second sorbent material relative to said second end and/or said second portion of said formed blended sorbent or said sorbent support. In embodiments, said second end and/or said second portion of said formed blended sorbent structure or said sorbent support can have a lower concentration of said one or more first sorbent material relative to said first end and/or said first portion of said formed blended sorbent or said sorbent support, and/or a higher concentration of said one or more second sorbent material relative to said first end and/or said first portion of said formed blended sorbent or said sorbent support.

In an embodiment of the third broad embodiment, said one or more first sorbent material and said one or more second sorbent material can be heterogeneously distributed and/or located on said formed blended sorbent support or said sorbent support having a gradient concentration or rate of change concentration between said first end of said sorbent support and said second end of said sorbent support.

In an embodiment of the third broad embodiment, said gradient concentration or rate of change concentration can be substantially constant between said first end of said sorbent support and said second end of said formed blended sorbent structure or said sorbent support.

In another embodiment of the third broad embodiment, said formed blended sorbent structure and/or said sorbent support can further comprise a first portion and a second portion of said formed blended sorbent structure or said sorbent support, wherein said one or more first sorbent material can be heterogeneously distributed and/or located on said formed blended sorbent structure or said sorbent support having a gradient concentration or rate of change concentration in said first portion of said formed blended sorbent structure or said sorbent support. In embodiments, said one or more second sorbent material can be substantially homogeneously distributed and/or substantially located in said second portion of said formed blended sorbent structure or said sorbent support. In a further embodiment, the first sorbent material is at least one of steam tolerant, oxidation tolerant, NOₓ tolerant, and/or SOₓ tolerant and the second sorbent material is at least one of steam intolerant, oxidation intolerant, NOₓ intolerant, and/or SOₓ intolerant.

In another embodiment of the third broad embodiment, said one or more second sorbent material can form a first layer or a proximal layer to and in contact with said formed blended sorbent structure or said sorbent support, and said one or more first sorbent materials can form a second layer or a distal layer to said formed blended sorbent structure or said sorbent support and in contact with said first layer or said proximal layer.

In another embodiment of the third broad embodiment, said one or more first sorbent material can substantially encapsulate said one or more second sorbent materials, and/or said one or more first sorbent material can form a distal layer and said one or more second sorbent material can form a proximal layer. In embodiments, said one or more first sorbent material and said one or more second sorbent material can be located on said formed blended sorbent structure or said sorbent support and optionally can be distributed substantially homogeneously between a first end of said formed blended sorbent structure or said sorbent support and a second end of said formed blended sorbent structure or said sorbent support.

In another embodiment of the third broad embodiment, said one or more first sorbent material can further comprise a water heat of sorption, a water sorption capacity, a target molecule heat of sorption, a target molecule sorption capacity, and said one or more second sorbent material can further comprise a water heat of sorption, a water sorption capacity, a target molecule heat of sorption, a target molecule sorption capacity. In embodiments, a sum product of said water sorption capacity multiplied by said water heat of sorption of said one or more first sorbent material and said one or more second sorbent material can be greater than a sum product of said target molecule sorption capacity multiplied by said target molecule heat of sorption of said one or more first sorbent material and said one or more second sorbent material.

In another embodiment of the third broad embodiment, said one or more second sorbent material is at least one of an intolerant sorbent material, a steam intolerant sorbent, an oxidation intolerant sorbent, a NOₓ intolerant sorbent, and/or a SOₓ intolerant sorbent.

In another embodiment of the third broad embodiment, said one or more second sorbent material is at least one of: a tolerant sorbent material, a steam tolerant sorbent, an oxidation tolerant sorbent, a NOx tolerant sorbent, a SOₓ tolerant sorbent, an intolerant sorbent material, a steam intolerant sorbent, an oxidation intolerant sorbent, a NOₓ intolerant sorbent, and/or a SOₓ intolerant sorbent.

In a fourth broad embodiment, a formed blended sorbent structure for separating a gas mixture can comprise one or more first sorbent material, one or more second sorbent material. In embodiments, the said one or more first sorbent material can be at least one of steam tolerant, oxidation tolerant, NOₓ tolerant, and/or SOₓ tolerant, and said one or more first sorbent material can further comprise a water sorption capacity, a water heat of sorption, a target molecule heat of sorption, and a target molecule sorption capacity. In other embodiments, the one or more second sorbent material can further comprise a water sorption capacity, a water heat of sorption, a target molecule heat of sorption, and a target molecule sorption capacity. In embodiments, a sum product of said water sorption capacity multiplied by said water heat of sorption of said one or more first sorbent material and said one or more second sorbent material can be greater than a sum product of said target molecule sorption capacity multiplied by said target molecule heat of sorption of said one or more first sorbent material and said one or more second sorbent material.

In an embodiment of the fourth broad embodiment, further comprise a sorbent support for supporting said one or more first sorbent material and said one or more second sorbent material.

In an embodiment of the fourth broad embodiment, said one or more first sorbent material is at least one of a tolerant sorbent material, a steam tolerant sorbent, an oxidation tolerant sorbent, a NOₓ tolerant sorbent, and/or a SOₓ tolerant sorbent.

In an embodiment of the fourth broad embodiment, said one or more second sorbent material is at least one of an intolerant sorbent material, a steam intolerant sorbent, an oxidation intolerant sorbent, a NOₓ intolerant sorbent, and/or a SOₓ intolerant sorbent.

In an embodiment of the fourth broad embodiment, said one or more second sorbent material is at least one of: a tolerant sorbent material, a steam tolerant sorbent, an oxidation tolerant sorbent, a NOₓ tolerant sorbent, a SOₓ tolerant sorbent, an intolerant sorbent material, a steam intolerant sorbent, an oxidation intolerant sorbent, a NOₓ intolerant sorbent, and/or a SOₓ intolerant sorbent.

In a fifth broad embodiment, a formed blended sorbent structure for separating a gas mixture can comprise a plurality of tolerant sorbent materials having at least two tolerant sorbent material (for example, a first tolerant sorbent material and a second tolerant sorbent material) having different sorption isotherms for water sorption for forming a blended sorbent, wherein a sorbent weight of said first tolerant sorbent material is equal to or greater than about 20%, 30%, or 40% of a sorbent weigh of said blended sorbent.

In an embodiment of the fifth broad embodiment, wherein a water sorption capacity of said first tolerant sorbent material can be equal to or greater than about 20%, 30%, or 40% of a water sorption capacity of said blended sorbent at a steam regeneration design condition such as when water sorption is at its maximum capacity during a regeneration step of a sorptive separation process, for example, when the blended sorbent is at a temperature between 100° C. to 160° C.

In an embodiment of the fifth broad embodiment, wherein an amount of steam used to desorb a fix amount of a target molecule can be decreased by at least 10% relative to any unblended sorbent material under a same operating cycle.

In an embodiment of the fifth broad embodiment, further comprise a sorbent support or forming elements for creating sheets or laminates or millimeter scale particles of said blended sorbent.

In a sixth broad embodiment, a sorbent contactor can comprise a plurality of formed blended sorbent structures, a plurality of a fluid passages, a first port fluidly connected to said plurality of said fluid passages, said first port located substantially at a first end of said formed blended sorbent structure and optionally at a first end of a sorbent support, and a second port fluidly connected to said plurality of said fluid passages, said second port located substantially at a second end of said formed blended sorbent structure and optionally at a second end of said sorbent support, wherein said plurality of said formed blended sorbent structure at least partially define said plurality of said fluid passages.

In an embodiment of the sixth broad embodiment, further comprise an enclosure for housing said plurality of said formed blended sorbent structure and said plurality of said fluid passages, said enclosure can have a first enclosure port fluidly connected to said first port and said plurality of said fluid passages and a second enclosure port fluidly connected to said second port and said plurality of said fluid passages.

In an embodiment of the sixth broad embodiment, said one or more first sorbent material or said one or more tolerant sorbent material can be located substantially adjacent or closest to said first port and within a volume of equal to or greater than about 20%, 30%, or 40% of a volume of said sorbent contactor.

In another embodiment of the sixth broad embodiment, said one or more first sorbent material or said one or more tolerant sorbent material can further comprise a water heat of sorption, a water sorption capacity, a target molecule heat of sorption, a target molecule sorption capacity; and said one or more second sorbent material or said one or more intolerant sorbent material can also further comprise a water heat of sorption, a water sorption capacity, a target molecule heat of sorption, a target molecule sorption capacity. In embodiments, a sum product of said water sorption capacity multiplied by said water heat of sorption of said one or more first sorbent material or said one or more tolerant sorbent material, and said one or more second sorbent material or said one or more intolerant sorbent material; can be greater than a sum product of said target molecule sorption capacity multiplied by said target molecule heat of sorption of said one or more first sorbent material or said one or more tolerant sorbent material, and said one or more second sorbent material or said one or more intolerant sorbent material.

In another embodiment of the sixth broad embodiment, a sum of heat capacities of said one or more first sorbent material or said one or more tolerant sorbent material, and said one or more second sorbent material or said one or more intolerant sorbent material can be equal to or greater than about 75% of a heat capacity of a formed blended sorbent structure having said one or more first sorbent material or said one or more tolerant sorbent material, and said one or more second sorbent material or said one or more intolerant sorbent material.

In another embodiment of the sixth broad embodiment, the sorbent contactor can further comprise a permeability value under laminar flow conditions of between about 2,000 Darcy to about 40,000 Darcy.

In another embodiment of the sixth broad embodiment, wherein said permeability value can be between said first port and said second port.

In another embodiment of the sixth broad embodiment, said first port and said second port can be located substantially on opposing ends of said plurality of said fluid passages and/or opposing ends of said plurality of said formed blended sorbent structure.

In another embodiment of the sixth broad embodiment, said one or more first sorbent material is at least one of a tolerant sorbent material, a steam tolerant sorbent, an oxidation tolerant sorbent, a NOₓ tolerant sorbent, and/or a SOₓ tolerant sorbent.

In another embodiment of the sixth broad embodiment, said one or more second sorbent material is at least one of: a tolerant sorbent material, a steam tolerant sorbent, an oxidation tolerant sorbent, a NOₓ tolerant sorbent, a SOₓ tolerant sorbent, an intolerant sorbent material, a steam intolerant sorbent, an oxidation intolerant sorbent, a NOₓ intolerant sorbent, and/or a SOₓ intolerant sorbent.

In another embodiment of the sixth broad embodiment, said sorbent contactor is a parallel passage sorbent contactor.

In a seventh broad embodiment, a sorptive gas separation process for separating a gas stream comprising at least a first molecule and a second molecule, can comprise providing a sorbent contactor having a plurality of a formed blended sorbent structures, admitting said gas stream into a first port or a second port of said sorbent contactor, sorbing at least a portion of said first molecule on and/or in said formed blended sorbent structure having at least said one or more first sorbent material and said one or more second sorbent material, recovering a first product fluid enriched in said second molecule from said first port or said second port of said sorbent contactor, admitting a steam stream into said first port of said sorbent contactor, desorbing at least a portion of said first molecule sorbed on at least one of said formed blended sorbent structures, said one or more first sorbent material, and said one or more second sorbent material; and recovering at least a portion of said first molecule from a second port of said sorbent contactor.

In an embodiment of the seventh broad embodiment, the process can further comprise generating a water heat of sorption and/or heat of condensation and employing said water heat of sorption as a heat of desorption for desorbing at least a portion of said first molecule sorbed on at least one of said formed blended sorbent structure, said one or more first sorbent material, and said one or more second sorbent material.

In another embodiment of the seventh broad embodiment, the process can further comprise at least one of admitting a gas stream having a relative humidity less than a relative humidity in said sorbent contactor and recovering water from said sorbent contactor, and/or applying a vacuum in said sorbent contactor and recovering water from said sorbent contactor.

In another embodiment of the seventh broad embodiment, said first molecule can be at least one of a carbon dioxide molecule, a sulfur oxide molecule, or a nitrogen oxide molecule.

In another embodiment of the seventh broad embodiment, said second molecule can be a nitrogen molecule or an oxygen molecule.

In another embodiment of the seventh broad embodiment, said steam stream further comprise a temperature in a range between 100° C. to 120° C.

In another embodiment of the seventh broad embodiment, the process can further comprise admitting said steam stream at an amount which saturates said one or more first sorbent material or less, at an amount which saturates said one or more first sorbent material and only a portion of said one or more second sorbent material, or at an amount insufficient to saturate both said one or more first sorbent material and said one or more second sorbent material.

In another embodiment of the seventh broad embodiment the process can further comprising admitting said steam stream to contact said one or more first sorbent material prior to contact with said one or more second sorbent material.

In another embodiment of the seventh broad embodiment, said one or more first sorbent material is at least one of a tolerant sorbent material, a steam tolerant sorbent, an oxidation tolerant sorbent, a NOₓ tolerant sorbent, and/or a SOₓ tolerant sorbent.

In another embodiment of the seventh broad embodiment, said one or more second sorbent material is at least one of: an intolerant sorbent material, a steam intolerant sorbent, an oxidation intolerant sorbent, a NOₓ intolerant sorbent, and/or a SOₓ intolerant sorbent.

In another embodiment of the seventh broad embodiment, said one or more second sorbent material is at least one of: a tolerant sorbent material, a steam tolerant sorbent, an oxidation tolerant sorbent, a NOₓ tolerant sorbent, a SOₓ tolerant sorbent, an intolerant sorbent material, a steam intolerant sorbent, an oxidation intolerant sorbent, a NOₓ intolerant sorbent, and/or a SOₓ intolerant sorbent.

In another embodiment of the seventh broad embodiment, said sorbent contactor is a parallel passage sorbent contactor.

1. A blended sorbent powder for separating a gas mixture comprising:
one or more tolerant sorbent material; and
one or more intolerant sorbent material,
wherein a sorbent weight of said one or more tolerant sorbent material is equal to or greater than 20% of a sorbent weight of said blended sorbent powder.

2. The blended sorbent powder of claim 1, wherein a water sorption capacity of said one or more tolerant sorbent material is equal to or greater than 20% of a water sorption capacity of said blended sorbent powder at a steam regeneration condition when water sorption is at its maximum capacity of a sorptive separation process, and
wherein said one or more tolerant sorbent material is at least one of steam tolerant, oxidation tolerant, NOₓ tolerant, and/or SOₓ tolerant.

3. The blended sorbent powder of claim 2, wherein said blended sorbent powder has at least a 1 mmol/g sorption capacity for a target molecule under the process condition used for sorption in the sorption separation process.

4. The blended sorbent powder of claim 1, 2 or 3, wherein said one or more tolerant sorbent material encapsulates said one or more intolerant sorbent materials, and wherein said one or more tolerant sorbent material forms a distal layer and said one or more intolerant sorbent material forms a proximal layer of said blended sorbent powder.

5. The blended sorbent powder of any one of claims 1 to 4,
wherein said one or more tolerant sorbent material further comprising a water heat of sorption, a water sorption capacity, a target molecule heat of sorption, a target molecule target sorption capacity,
wherein said one or more intolerant sorbent material further comprising a water heat of sorption, a water sorption capacity, a target molecule heat of sorption, a target molecule target sorption capacity, and
wherein a sum product of said water sorption capacity multiplied by said water heat of sorption of said one or more tolerant sorbent material and said one or more intolerant sorbent material is greater than a sum product of said target molecule sorption capacity multiplied by said target molecule heat of sorption of said one or more tolerant sorbent material and said one or more intolerant sorbent material.

6. A blended sorbent powder comprising:
a first tolerant sorbent material, wherein said first tolerant sorbent material is at least one of steam tolerant, oxidation tolerant, NOₓ tolerant, and/or SOₓ tolerant, and further comprising a water sorption capacity, a water heat of sorption, a target molecule heat of sorption, and a target molecule sorption capacity; and
one or more second sorbent material further comprising a water sorption capacity, a water heat of sorption, a target molecule heat of sorption, and a target molecule sorption capacity,
wherein said first tolerant sorbent material and said second sorbent material differ by at least one of a water sorption capacity, a water heat of sorption, a target molecule sorption capacity, and a target molecule heat of sorption, and
wherein a sum product of said water sorption capacity multiplied by said water heat of sorption of said one or more first tolerant sorbent material and said one or more second sorbent material is greater than a sum product of said target molecule sorption capacity multiplied by said target molecule heat of sorption of said first tolerant sorbent material and said one or more second sorbent material.

7. The blended sorbent powder of claim 6, wherein said second sorbent material is at least one of an intolerant sorbent material, a steam intolerant sorbent, an oxidation intolerant sorbent, a NOₓ intolerant sorbent, and/or a SOₓ intolerant sorbent.

8. The blended sorbent powder of claim 6, wherein said second sorbent material is at least one of: a tolerant sorbent material, a steam tolerant sorbent, an oxidation tolerant sorbent, a NOₓ tolerant sorbent, a SOₓ tolerant sorbent, an intolerant sorbent material, a steam intolerant sorbent, an oxidation intolerant sorbent, a NOₓ intolerant sorbent, and/or a SOₓ intolerant sorbent.

9. A formed blended sorbent structure for separating a gas mixture comprising:
one or more first sorbent material; and
one or more second sorbent material, for combining with said one or more first sorbent material forming a blended sorbent,
wherein a sorbent weight of said one or more first sorbent material is equal to or greater than 20% of a sorbent weigh of said blended sorbent,
wherein said one or more first sorbent material is at least one of a tolerant sorbent material, a steam tolerant sorbent, an oxidation tolerant sorbent, a NOₓ tolerant sorbent, and/or a SOₓ tolerant sorbent.

10. The formed blended sorbent structure of claim 9, wherein a water sorption capacity of said one or more first sorbent material is equal to or greater than 20% of a water sorption capacity of said blended sorbent at its maximum capacity in a sorptive separation process.

11. The formed blended sorbent structure of claim 9 or 10, further comprising a sorbent support or forming elements for creating sheets or laminates or millimeter scale particles of said blended sorbent.

12. The formed blended sorbent structure of claim 11, wherein said sorbent support is in a form of a sheet, a flat sheet, a planar sheet, and/or a laminate, with a thickness in a range of between 100 micrometers to 3000 micrometers.

13. The formed blended sorbent structure of any one of claims 9 to 12, wherein a sum of a heat capacity of said one or more first sorbent material and said one or more second sorbent material is equal to or greater than 75% of a heat capacity of said formed blended sorbent.

14. The formed blended sorbent structure of any one of claims 9 to 13, wherein said formed blended sorbent structure is in a form of a sheet, a flat sheet, a planar sheet, and/or a laminate, with a thickness in a range of between 100 micrometers to 3000 micrometers.

15. The formed blended sorbent structure of any one of claims 9 to 14, wherein said formed blended sorbent structure and/or said sorbent support further comprises a first end and a second end,
wherein said one or more first sorbent material is homogeneously distributed and/or located adjacent to said first end, and said one or more second sorbent material is homogeneously distributed and/or located adjacent to said second end.

16. The formed blended sorbent structure of any one of claims 9 to 14, wherein said formed blended sorbent structure and/or said sorbent support further comprises a first end and a second end,
wherein said one or more first sorbent material and said one or more second sorbent material are heterogeneously distributed and/or located on said formed blended sorbent structure or said sorbent support.

17. The formed blended sorbent structure of claim 16, wherein said first end has a higher concentration of said one or more first sorbent material relative to said second end, and has a lower concentration of said one or more second sorbent material relative to said second end,
wherein said second end has a lower concentration of said one or more first sorbent material relative to said first end, and has a higher concentration of said one or more second sorbent material relative to said first end.

18. The formed blended sorbent structure of claim 16 or 17, wherein said heterogeneous distribution further comprises a gradient concentration between said first end of said formed blended sorbent structure and said second end of said formed blended sorbent structure.

19. The formed blended sorbent structure of claim 18, wherein the gradient concentration is constant between said first end of said formed blended sorbent structure and said second end of said formed blended sorbent structure.

20. The formed blended sorbent structure of any one of claims 9 to 14, wherein said formed blended sorbent structure and/or said sorbent support further comprises a first portion and a second portion of said formed blended sorbent structure,
wherein said one or more first sorbent material are heterogeneously distributed and/or located on said formed blended sorbent structure or said sorbent support and has a gradient concentration in said first portion of said formed blended sorbent structure or said sorbent support, and
wherein said one or more second sorbent material is homogeneously distributed and/or located in said second portion of said formed blended sorbent structure or said sorbent support.

21. The formed blended sorbent structure of any one of claims 9 to 14, wherein said one or more second sorbent materials form a first layer or a proximal layer to and in contact with said formed blended sorbent structure or said sorbent support, and
wherein said one or more first sorbent materials form a second layer or a distal layer to said formed blended sorbent structure or said sorbent support and in contact with said first layer or said proximal layer.

22. The formed blended sorbent structure of any one of claims 9 to 14, wherein said one or more first sorbent material encapsulates said one or more second sorbent materials,
wherein said one or more first sorbent material forms a distal layer and said one or more second sorbent material forms a proximal layer, and
wherein said one or more first sorbent material and said one or more second sorbent material are located on said formed blended sorbent structure or said sorbent support.

23. The formed blended sorbent structure of claim 22, wherein said one or more first sorbent material and said one or more second sorbent material are distributed homogeneously between a first end of said formed blended sorbent structure or said sorbent support, and a second end of said formed blended sorbent structure or said sorbent support.

24. The formed blended sorbent structure of any one of claims 9 to 23,
wherein said one or more first sorbent material further comprises a water heat of sorption, a water sorption capacity, a target molecule heat of sorption, a target molecule sorption capacity,
wherein said one or more second sorbent material further comprises a water heat of sorption, a water sorption capacity, a target molecule heat of sorption, a target molecule sorption capacity, and
wherein a sum product of said water sorption capacity multiplied by said water heat of sorption of said one or more first sorbent material and said one or more second sorbent material is greater than a sum product of said target molecule sorption capacity multiplied by said target molecule heat of sorption of said one or more first sorbent material and said one or more second sorbent material.

25. The formed blended sorbent structure of any one of claims 9 to 24, wherein said one or more second sorbent material is at least one of an intolerant sorbent material, a steam intolerant sorbent, an oxidation intolerant sorbent, a NOₓ intolerant sorbent, and/or a SOₓ intolerant sorbent.

26. The formed blended sorbent structure of any one of claims 9 to 24, wherein said one or more second sorbent material is at least one of: a tolerant sorbent material, a steam tolerant sorbent, an oxidation tolerant sorbent, a NOₓ tolerant sorbent, a SOₓ tolerant sorbent, an intolerant sorbent material, a steam intolerant sorbent, an oxidation intolerant sorbent, a NOₓ intolerant sorbent, and/or a SOₓ intolerant sorbent

27. A formed blended sorbent structure for separating a gas mixture comprising:
one or more first sorbent material;
one or more second sorbent material; and
wherein said one or more first sorbent material is at least one of a tolerant sorbent material, a steam tolerant sorbent, an oxidation tolerant sorbent, a NOₓ tolerant sorbent, and/or a SOₓ tolerant sorbent, and said one or more first sorbent material further comprising a water sorption capacity, a water heat of sorption, a target molecule heat of sorption, and a target molecule sorption capacity,
wherein said one or more second sorbent material further comprising a water sorption capacity, a water heat of sorption, a target molecule heat of sorption, and a target molecule sorption capacity,
wherein a sum product of said water sorption capacity multiplied by said water heat of sorption of said one or more first sorbent material and said one or more second sorbent material is greater than a sum product of said target molecule sorption capacity multiplied by said target molecule heat of sorption of said one or more first sorbent material and said one or more second sorbent material.

28. The formed blended sorbent structure of claim 27, further comprising a sorbent support for supporting said one or more first sorbent material and said one or more second sorbent material.

29. The formed blended sorbent structure of claim 27 or 28, where the said one or more second sorbent material is at least one of an intolerant sorbent material a steam intolerant sorbent, an oxidation intolerant sorbent, a NOₓ intolerant sorbent, and/or a SOₓ intolerant sorbent.

30. The formed blended sorbent structure of claim 27 or 28, where the said one or more second sorbent material is at least one of a tolerant sorbent material, a steam tolerant sorbent, an oxidation tolerant sorbent, a NOₓ tolerant sorbent, a SOₓ tolerant sorbent, an intolerant sorbent material, a steam intolerant sorbent, an oxidation intolerant sorbent, a NOₓ intolerant sorbent, and/or a SOₓ intolerant sorbent.

31. A formed blended sorbent structure for separating a gas mixture comprising:
a plurality of tolerant sorbent materials having at least a first tolerant sorbent and a second tolerant sorbent for forming a blended sorbent, wherein said first tolerant sorbent and said second tolerant sorbent have different sorption isotherms for water sorption, and is at least one of a steam intolerant sorbent, an oxidation intolerant sorbent, a NOₓ intolerant sorbent, and/or a SOₓ intolerant sorbent,
wherein a sorbent weight of said first tolerant sorbent material is equal to or greater than 20%, of a sorbent weigh of said blended sorbent.

32. The formed blended sorbent structure of claim 31, wherein a water sorption capacity of said first tolerant sorbent material is equal to or greater than 20%, of a water sorption capacity of said blended sorbent at a condition when water sorption is at its maximum capacity during a sorptive separation process.

33. The formed blended sorbent structure of claim 31 or 32, wherein an amount of steam used to desorb a fix amount of a target molecule is decreased by at least 10% relative to any unblended sorbent material under a same operating cycle.

34. The formed blended sorbent structure of any one of claims 31 to 33, further comprising a sorbent support or forming elements for creating sheets or laminates or millimeter scale particles of said blended sorbent.

35. A sorbent contactor comprising:
a plurality of said formed blended sorbent structure of any one of claims 9 to 34;
a plurality of a fluid passages;
a first port fluidly connected to said plurality of said fluid passages located at a first end of said formed blended sorbent structure; and
a second port fluidly connected to said plurality of said fluid passages located at a second end of said formed blended sorbent structure,
wherein said plurality of said formed blended sorbent structure at least partially define said plurality of said fluid passages.

36. The sorbent contactor of claim 35, further comprising an enclosure for housing said plurality of said formed blended sorbent structure and said plurality of said fluid passages, said enclosure having a first enclosure port fluidly connected to said first port and said fluid passages and a second enclosure port fluidly connected to said second port and said fluid passages.

37. The sorbent contactor of claim 35 or 36, wherein said one or more first sorbent material is located adjacent or closest to said first port and within a volume of equal to or greater than 20% of a volume of said sorbent contactor.

38. The sorbent contactor of any one of claims 35 to 37, wherein said one or more first sorbent material further comprises a water heat of sorption, a water sorption capacity, a target molecule heat of sorption, a target molecule sorption capacity,
wherein said one or more second sorbent material further comprising a water heat of sorption, a water sorption capacity, a target molecule heat of sorption, a target molecule sorption capacity, and
wherein a sum product of said water sorption capacity multiplied by said water heat of sorption of said one or more first sorbent material and said one or more second sorbent material is greater than a sum product of said target molecule sorption capacity multiplied by said target molecule heat of sorption of said one or more first sorbent material and said one or more second sorbent material.

39. The sorbent contactor of any one of claims 35 to 38, wherein a sum of heat capacities of said one or more first sorbent material and said one or more second sorbent material is equal to or greater than 75% of a heat capacity of said formed blended sorbent structure.

40. The sorbent contactor of any one of claims 35 to 39, further comprising a permeability value under laminar flow conditions of between 2,000 Darcy to 40,000 Darcy.

41. The sorbent contactor of claim 40, wherein said permeability value is between said first port and said second port.

42. The sorbent contactor of any one of claims 35 to 41, wherein said first port and said second port are located on opposing ends of said fluid passages and/or opposing ends of said plurality of said formed blended sorbent structure.

43. The sorbent contactor of any one of claims 35 to 42, wherein said sorbent contactor is a parallel passage sorbent contactor.

44. A sorptive gas separation process for separating a gas stream, said gas stream comprising at least a first molecule and a second molecule, the process comprising:
(a) providing a sorbent contactor of any one of claims 35 to 43, having a plurality of a formed blended sorbent structures;
(b) admitting said gas stream into said first port or said second port of said sorbent contactor;
(c) sorbing at least a portion of said first molecule on and/or in said formed blended sorbent structure, having at least one or more first sorbent material or said one or more tolerant sorbent material, and one or more second sorbent material or said one or more intolerant sorbent material;
(d) recovering a first product fluid enriched in said second molecule from said first port or said second port of said sorbent contactor;
(e) admitting a steam stream into said first port of said sorbent contactor;
(f) desorbing at least a portion of said first molecule sorbed on at least one of said formed blended sorbent structure, said one or more first sorbent material, said one or more tolerant sorbent material, said one or more second sorbent material, and said one or more intolerant sorbent material; and
(g) recovering at least a portion of said first molecule from said second port of said sorbent contactor.

45. The process of claim 44, further comprising in step (e) generating a water heat of sorption and/or heat of condensation and employing said water heat of sorption as a heat of desorption for desorbing at least a portion of said first molecule sorbed on at least one of said formed blended sorbent structure, said one or more first sorbent material, said one or more tolerant sorbent material, said one or more second sorbent material, and said one or more intolerant sorbent material, in step (f).

46. The process of claim 44 or 45, after step (g) further comprising at least one of:
admitting a gas stream having a relative humidity less than a relative humidity in said sorbent contactor during step (f), and recovering water from said sorbent contactor; and/or
applying a vacuum in said sorbent contactor, and recovering water from said sorbent contactor.

47. The process of claim 44, 45, or 46, wherein said first molecule is at least one of a carbon dioxide molecule, a sulfur oxide molecule, or a nitrogen oxide molecule.

48. The process of claim 44, 45, or 46, wherein said second molecule is a nitrogen molecule or an oxygen molecule.

49. The process of any one of claims 44 to 48, wherein during step (e), said steam stream further comprising a temperature in a range between 100° C. to 120° C.

50. The process of any one of claims 44 to 49, wherein during step (e), further comprising admitting said steam stream at an amount which saturates said one or more tolerant sorbent material or less, at an amount which saturates said one or more tolerant sorbent material and only a portion of said one or more intolerant sorbent material, or at an amount insufficient to saturate both said one or more tolerant sorbent material and said one or more intolerant sorbent material.

51. The process of any one of claims 44 to 50, wherein during step (e), further comprising admitting said steam stream to contact said one or more first sorbent material or said one or more tolerant sorbent material, prior to contact with said one or more second sorbent material or said one or more intolerant sorbent material.
